(19) United States
(12) Patent Application Publication
(10) Pub. No.: US 2025/0249360 A1
(43) Pub. Date: Aug. 7, 2025

(54) GAME SYSTEM, ONE OR MORE NON-TRANSITORY COMPUTER-READABLE STORAGE MEDIA HAVING GAME PROGRAM STORED THEREIN, COMPUTER IMPLEMENTED METHOD, AND GAME APPARATUS

(71) Applicant: Nintendo Co., Ltd., Kyoto (JP)

(72) Inventor: Kenta KUBO, Kyoto (JP)

(21) Appl. No.: 18/958,688

(22) Filed: Nov. 25, 2024

(30) Foreign Application Priority Data
Feb. 2, 2024 (JP) 2024-015229
Feb. 2, 2024 (JP) 2024-015233

(51) Int. Cl. A63F 13/52

(52) U.S. Cl. CPC A63F 13/52

(57) ABSTRACT

A game system includes one or more processors, and the one or more processors are configured to: start a first game; process the first game, based on an operation input by a user; generate a game image including a first image based on the first game; if a game state satisfies a first condition in the first game, cause the game state to transition to a state before the first condition is satisfied; and if the game state satisfies a second condition in the first game, stop or end processing of the first game.

### CROSS REFERENCE TO RELATED APPLICATION

This application claims priority to Japanese Patent Application Nos. 2024-015229 and 2024-015233, filed on Feb. 2, 2024, the entire contents of which are incorporated herein by reference.

### FIELD

The present disclosure relates to game processing for measuring and competing for the time taken to play a game.

### BACKGROUND AND SUMMARY

Hitherto, a game system in which, after the progress of a game stops due to a game over or the like, a game screen in a state before the stop is reproduced, and the game is started again even though the screen had reached the game stop state, has been known.

The above system is, so to speak, to restart play when a mistake is made, but there are cases where the system cannot be used in a game for competing for the time until a clear condition is achieved, such as a time attack type game. For example, in conventional time attack type games, it is common to end a time attack game at a time point where a mistake occurs.

In view of the above, the following configuration examples are disclosed.

### Configuration 1

Configuration 1 is directed to one or more non-transitory computer-readable storage media having stored therein a game program causing one or more processors of a game system to: start a first game; process the first game, based on an operation input by a user; generate a game image including a first image based on the first game; if a game state satisfies a first condition in the first game, cause the game state to transition to a state before the first condition is satisfied; and if the game state satisfies a second condition in the first game, stop or end processing of the first game.

According to the above configuration, if the first condition is satisfied during the first game, the game state can be returned to the state before the first condition is satisfied, and play of the first game can be continued. Accordingly, for example, even in a situation in which play cannot be continued due to satisfaction of the first condition, it is possible to immediately give an opportunity to restart the game to advance the game by preventing the first condition from being satisfied, thereby allowing the user to play the first game until the second condition is satisfied.

### Configuration 2

In Configuration 2 based on Configuration 1 above, the game program may further cause the one or more processors to measure an elapsed time from the start of the game until the second condition is satisfied, including a time taken for the transition of the game state.

According to the above configuration, the total elapsed time including the time taken for the game state to transition can be measured. Accordingly, it is possible to provide a game system for competing for the time taken for a series of game plays including restart.

### Configuration 3

In Configuration 3 based on Configuration 1 above, the first condition may be a condition satisfied when at least one of falling of an operation character acting based on the operation input, damage to the operation character, and entry of the operation character into a location other than a pre-specified location occurs.

According to the above configuration, it is possible to promote smooth clearing of the first game within a predetermined range.

### Configuration 4

In Configuration 4 based on Configuration 1 above, the game program may further cause the one or more processors to store the game state in each frame from a current frame to a frame before a predetermined period in the first game, and cause the game state to transition to a game state in a predetermined frame before the first condition is satisfied, if the first condition is satisfied.

According to the above configuration, if the first condition is satisfied, the game state can be returned to a state where the condition is not satisfied, and then game play can be restarted.

### Configuration 5

In Configuration 5 based on Configuration 1 above, the game program may further cause the one or more processors to, if the game state satisfies the first condition, cause the game state to transition to a game state before the first condition is satisfied, by causing the game state to sequentially transition to the game state in each frame to the frame before the predetermined period.

According to the above configuration, it is possible to represent the game state such that the game state is reversely reproduced, and it is possible to present to the user in an easy-to-understand manner a state where the game state is returning to a previous state. Accordingly, it is possible to allow the user to more reliably recognize that the game state has returned.

### Configuration 6

In Configuration 6 based on Configuration 1 above, the game program may further cause the one or more processors to, if the game state satisfies the first condition, cause the game state to transition to a game state before the first condition is satisfied, after a predetermined waiting period has elapsed.

According to the above configuration, it is possible to allow the user to more reliably grasp that the first condition has been satisfied.

### Configuration 7

In Configuration 7 based on Configuration 1 above, the game program may further cause the one or more processors to, if the game state satisfies the first condition, cause the game state to transition to a game state at the start of the first game.

### Configuration 8

In Configuration 8 based on Configuration 1 above, the game program may further cause the one or more processors to cause the first game to operate by an emulator.

### Configuration 9

In Configuration 9 based on Configuration 1 above, the game program may further cause the one or more processors to: simultaneously start the first game and at least one second game that is the same as the first game and operates based on operation history information that is a history of an operation input; process the at least one second game, based on at least one piece of the operation history information; generate the game image including at least one second game image based on the second game; if the first condition is satisfied in the second game, causes the game state to transition to a game state before the first condition is satisfied; and if the second condition is satisfied in the second game, stop or end processing of the second game.

According to the above configuration, it is possible to provide a play experience as if competing against the play of the second game operating based on the operation history information.

### Configuration 10

In Configuration 10 based on Configuration 1 above, the game program may further cause the one or more processors to store a history of the operation input in the first game as the operation history information.

According to the above configuration, it is possible to automatically record the history while the user is playing the game.

### Configuration 11

In Configuration 11 based on Configuration 1 above, the game program may further cause the one or more processors to process the second game, based on the operation history information stored by another game system.

According to the above configuration, the second game is executed based on the operation history of another user, so that it is possible to provide a play experience as if competing against the other user in real time.

### Configuration 12

In Configuration 12 based on Configuration 10 above, the game program may further cause the one or more processors to process the second game, based on the operation history information obtained when the elapsed time from the start of the first game until the second condition is satisfied is shortest.

According to the above configuration, it is possible to provide a time attack type game for competing for the time until the second condition is satisfied.

### Configuration 13

In Configuration 13 based on Configuration 11 above, the game program may further cause the one or more processors to start the first game and the second game next in a predetermined order only if a third condition is satisfied in a series of games in which a plurality of types of the first games and the second games are performed continuously in the predetermined order.

### Configuration 14

In Configuration 14 based on Configuration 13 above, the third condition may be a condition that, in rankings based on results of end of a predetermined first game and a predetermined second game in the series of games, a ranking based on the result of the end of the first game is within a predetermined ranking.

According to the above configuration, it is possible to provide a knockout tournament type game.

### Configuration 15

In Configuration 15 based on Configuration 13 above, the game program further causes the one or more processors to process the plurality of types of the second games executed in the predetermined order in the series of games, based on the operation history information of the plurality of types of the second games stored by another single game system, respectively.

According to the above configuration, in a knockout tournament type game, an opponent can be the same opponent in the case of winning to the next round, so that it is possible to provide a play experience as if playing a knockout tournament with the same opponent.

### Configuration 16

In Configuration 16 based on Configuration 1 above, the game system may include a plurality of game apparatuses including the processors, and a server, and the game program may further cause the one or more processors to upload play record data including information of an elapsed time from the start of the first game until the second condition is satisfied in the first game, to the server. Furthermore, the server may determine a ranking, based on the uploaded play record.

According to the above configuration, it is possible to provide an online game for competing against other users for the time until the second condition is satisfied in the first game.

Another configuration example is directed to a game system including one or more processors, the one or more processors being configured to: start a first game processed based on an operation input by a user and ending when a first condition is satisfied; start measuring an elapsed time from the start of the first game until the first condition is satisfied, together with the start of the first game; generate a game image including a first image based on the first game; if a game state satisfies a second condition in the first game, cause the game state to automatically transition to a state before the second condition is satisfied; and if the first condition is satisfied in the first game, perform an evaluation process of evaluating the elapsed time measured including a time taken to cause the game state to transition.

According to the present disclosure, it is possible to accurately measure the elapsed time until the second condition is satisfied, while allowing the user to play the first game until the second condition is satisfied.

### BRIEF DESCRIPTION OF THE DRAWINGS

FIG. 1 is a schematic diagram showing a non-limiting example of the entire configuration of a game system according to an exemplary embodiment;

FIG. 2 is a block diagram showing a non-limiting example of the hardware configuration of a server 1000;

FIG. 3 shows a non-limiting example of a state where a left controller 3 and a right controller 4 are attached to a main body apparatus 2;

FIG. 4 shows a non-limiting example of a state where the left controller 3 and the right controller 4 are detached from the main body apparatus 2;

FIG. 5 is six orthogonal views showing a non-limiting example of the main body apparatus 2;

FIG. 6 is six orthogonal views showing a non-limiting example of the left controller 3;

FIG. 7 is six orthogonal views showing a non-limiting example of the right controller 4;

FIG. 8 is a block diagram showing a non-limiting example of the internal configuration of the main body apparatus 2;

FIG. 9 is a block diagram showing non-limiting examples of the internal configurations of the main body apparatus 2, the left controller 3, and the right controller 4;

FIG. 10 is a non-limiting example diagram for describing a competition in the exemplary embodiment;

FIG. 11 is a non-limiting example diagram for describing the competition in the exemplary embodiment;

FIG. 12 is a non-limiting example diagram for describing the competition in the exemplary embodiment;

FIG. 13 is a non-limiting example diagram for describing the competition in the exemplary embodiment;

FIG. 14 shows a non-limiting example of a screen for the competition;

FIG. 15 shows a non-limiting example of an operation information image;

FIG. 16 is a non-limiting example diagram for describing a state return process;

FIG. 17 is a non-limiting example diagram for describing the state return process;

FIG. 18 is a non-limiting example diagram for describing the state return process;

FIG. 19 is a non-limiting example diagram for describing the state return process;

FIG. 20 is a non-limiting example diagram for describing the state return process;

FIG. 21 is a non-limiting example diagram for describing the state return process;

FIG. 22 is a non-limiting example diagram for describing the state return process;

FIG. 23 is a non-limiting example diagram for describing the state return process;

FIG. 24 is a non-limiting example diagram for describing the state return process;

FIG. 25 shows a non-limiting example of a screen for a time attack mode;

FIG. 26 shows a non-limiting example of a screen for a survival mode;

FIG. 27 shows a non-limiting example of the screen for the survival mode;

FIG. 28 shows a non-limiting example of the screen for the survival mode;

FIG. 29 shows a non-limiting example of the screen for the survival mode;

FIG. 30 shows a non-limiting example of the screen for the survival mode;

FIG. 31 shows a non-limiting example of the screen for the survival mode;

FIG. 32 shows a non-limiting example of a screen for a contest mode;

FIG. 33 illustrates a memory map showing a non-limiting example of various kinds of data stored in a storage section 1002 of the server 1000;

FIG. 34 shows a non-limiting example of the data structure of entry data 302;

FIG. 35 illustrates a memory map showing a non-limiting example of various kinds of data stored in a DRAM 85 of a game apparatus 1;

FIG. 36 is a non-limiting example flowchart showing the details of time attack mode processing;

FIG. 37 is a non-limiting example flowchart showing the details of the time attack mode processing;

FIG. 38 is a non-limiting example flowchart showing the details of the state return process;

FIG. 39 is a non-limiting example flowchart showing the details of survival mode processing;

FIG. 40 is a non-limiting example flowchart showing the details of the survival mode processing;

FIG. 41 is a non-limiting example flowchart showing the details of the survival mode processing;

FIG. 42 is a non-limiting example flowchart showing the details of contest mode processing;

FIG. 43 is a non-limiting example flowchart showing the details of the contest mode processing; and

FIG. 44 is a non-limiting example flowchart showing the details of server processing executed by the server 1000.

### DETAILED DESCRIPTION OF NON-LIMITING EXAMPLE EMBODIMENTS

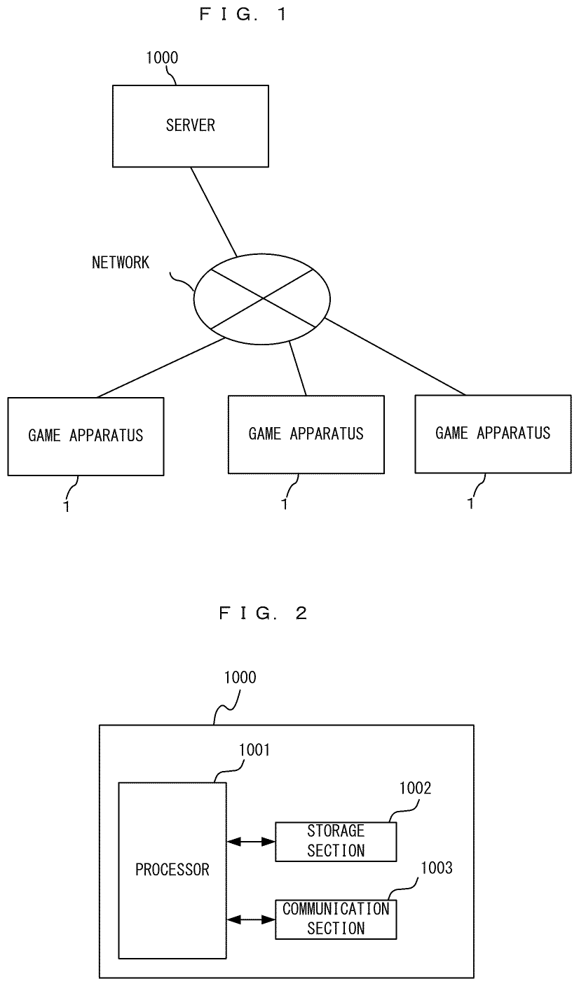

Hereinafter, one exemplary embodiment will be described. FIG. 1 is a schematic diagram showing the entire configuration of an information processing system according to the exemplary embodiment. The information processing system of the exemplary embodiment includes a plurality of game apparatuses 1 and a server 1000. The server 1000 and each game apparatus 1 are configured to be able to communicate with each other via a network such as the Internet. In the exemplary embodiment, with this configuration, game processing executed by each game apparatus 1 by communicating with the server 1000 as necessary will be described as an example.

### [Hardware Configuration of Server]

Next, the hardware configurations of the server 1000 will be described. FIG. 2 is a block diagram showing the hardware configuration of the server 1000. The server 1000 includes at least a processor 1001, a storage section 1002, and a communication section 1003. The processor 1001 executes various programs for controlling the server 1000. In the storage section 1002, various programs to be executed by the processor 1001 and various kinds of data to be used by the processor 1001 are stored. The communication section 1003 connects to the network by means of wired or wireless communication and transmits/receives predetermined data to/from the game apparatus 1. In the exemplary embodiment, an example in which there is one server 1000 is illustrated, but the server 1000 may be a single server or may be configured as a group of servers that perform distributed processing.

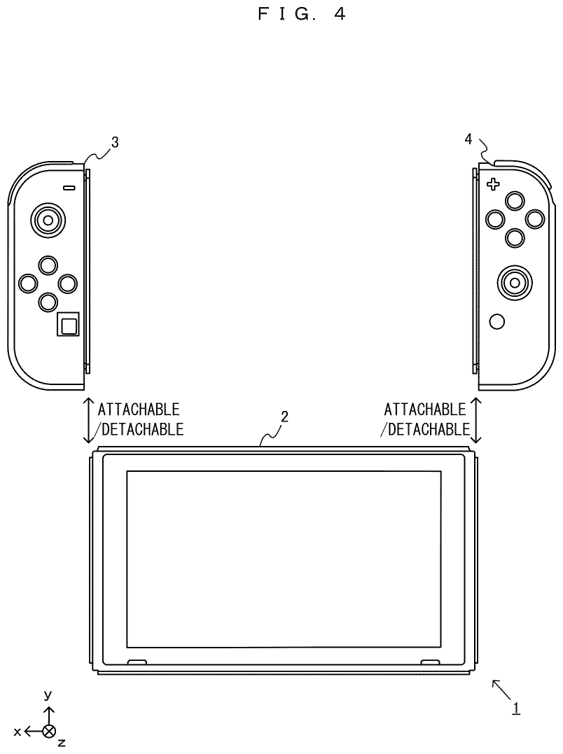

Next, the above game apparatus 1 will be described. An example of the game apparatus 1 according to the exemplary embodiment is a game apparatus including a main body apparatus 2, a left controller 3, and a right controller 4. Each of the left controller 3 and the right controller 4 is attachable to and detachable from the main body apparatus 2. That is, the game apparatus 1 can be used as a unified apparatus obtained by attaching each of the left controller 3 and the right controller 4 to the main body apparatus 2. Moreover, in the game apparatus 1, the main body apparatus 2, the left controller 3, and the right controller 4 can also be used as separate bodies (see FIG. 4).

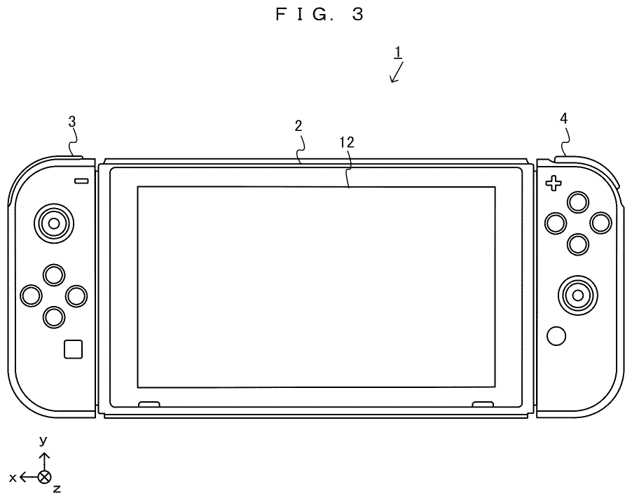

FIG. 3 shows an example of the state where the left controller 3 and the right controller 4 are attached to the main body apparatus 2. As shown in FIG. 3, each of the left controller 3 and the right controller 4 is attached to and unified with the main body apparatus 2. The main body apparatus 2 is an apparatus for performing game processing. The main body apparatus 2 includes a display 12. Each of the left controller 3 and the right controller 4 is an apparatus including operation sections with which a player provides inputs.

FIG. 4 shows an example of the state where each of the left controller 3 and the right controller 4 is detached from the main body apparatus 2. As shown in FIGS. 3 and 4, the left controller 3 and the right controller 4 are attachable to and detachable from the main body apparatus 2. Hereinafter, the left controller 3 and the right controller 4 may be collectively referred to as “controller”.

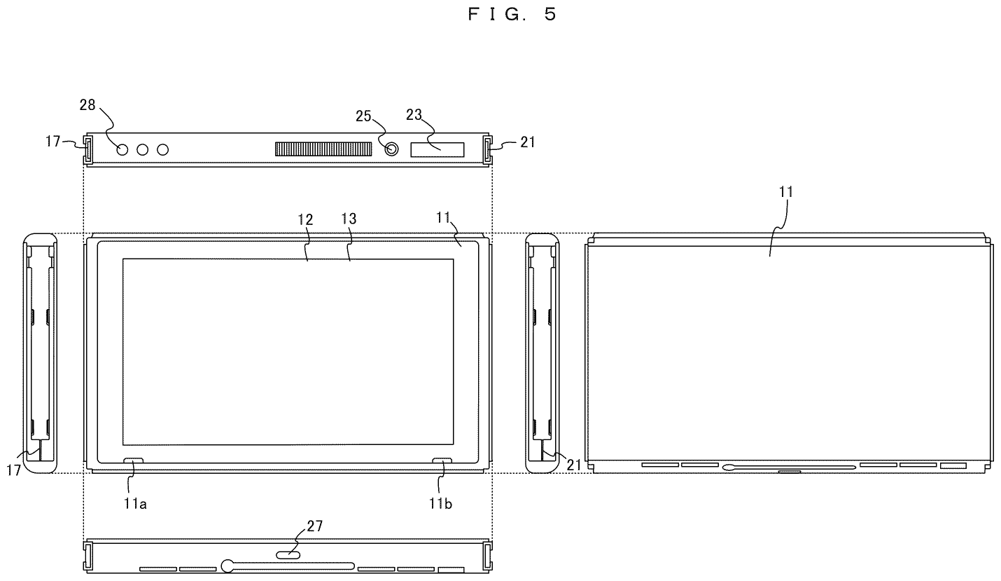

FIG. 5 is six orthogonal views showing an example of the main body apparatus 2. As shown in FIG. 5, the main body apparatus 2 includes an approximately plate-shaped housing 11. In the exemplary embodiment, a main surface (in other words, a surface on a front side, i.e., a surface on which the display 12 is provided) of the housing 11 has a substantially rectangular shape.

The shape and the size of the housing 11 are discretionary. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

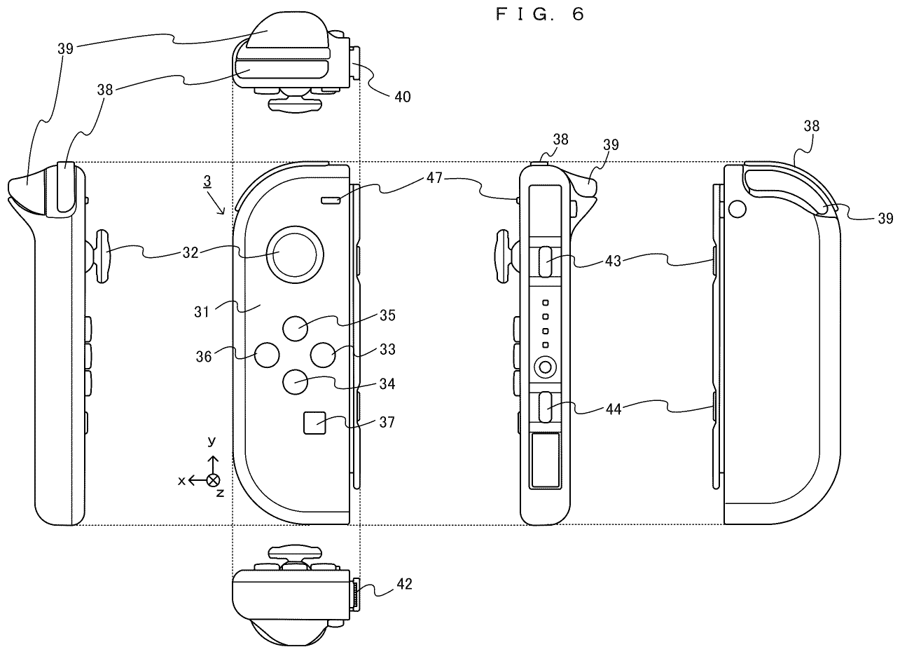

As shown in FIG. 6, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

The main body apparatus 2 includes a touch panel 13 on the screen of the display 12. In the exemplary embodiment, the touch panel 13 is of a type capable of receiving a multi-touch input (e.g., electrical capacitance type). However, the touch panel 13 may be of any type, and may be, for example, of a type capable of receiving a single-touch input (e.g., resistive film type).

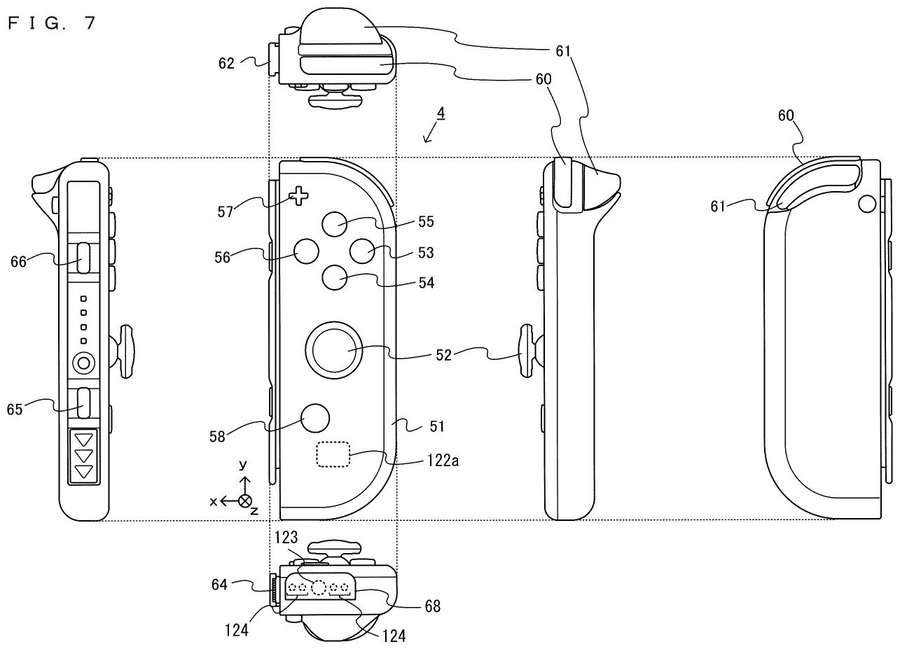

The main body apparatus 2 includes speakers (i.e., speakers 88 shown in FIG. 7) within the housing 11. As shown in FIG. 5, speaker holes 11a and 11b are formed in the main surface of the housing 11. Then, sounds outputted from the speakers 88 are outputted through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 5, the main body apparatus 2 includes a slot 23. The slot 23 is provided at an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game apparatus 1 and an information processing apparatus of the same type as the game apparatus 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game apparatus 1 can display on a stationary monitor an image generated by and outputted from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

FIG. 6 is six orthogonal views showing an example of the left controller 3. As shown in FIG. 6, the left controller 3 includes a housing 31. In the exemplary embodiment, the housing 31 has a vertically long shape, i.e., is shaped to be long in an up-down direction shown in FIG. 6 (i.e., a z-axis direction shown in FIG. 6). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly, the left hand. Further, the left controller 3 can also be held in the orientation in which the left controller 3 is horizontally long. When held in the orientation in which the left controller 3 is horizontally long, the left controller 3 may be held with both hands.

The left controller 3 includes a left analog stick (hereinafter, referred to as a “left stick”) 32 as an example of a direction input device. As shown in FIG. 6, the left stick 32 is provided on a main surface of the housing 31. The left stick 32 can be used as a direction input section with which a direction can be inputted. The player tilts the left stick 32 and thereby can input a direction corresponding to the direction of the tilt (and input a magnitude corresponding to the angle of the tilt). The left controller 3 may include a directional pad, a slide stick that allows a slide input, or the like as the direction input section, instead of the analog stick. Further, in the exemplary embodiment, it is possible to provide an input by pressing the left stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

FIG. 7 is six orthogonal views showing an example of the right controller 4. As shown in FIG. 7, the right controller 4 includes a housing 51. In the exemplary embodiment, the housing 51 has a vertically long shape, i.e., is shaped to be long in the up-down direction shown in FIG. 7 (i.e., the z-axis direction shown in FIG. 6). In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes a right analog stick (hereinafter, referred to as a “right stick”) 52 as a direction input section. In the exemplary embodiment, the right stick 52 has the same configuration as that of the left stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

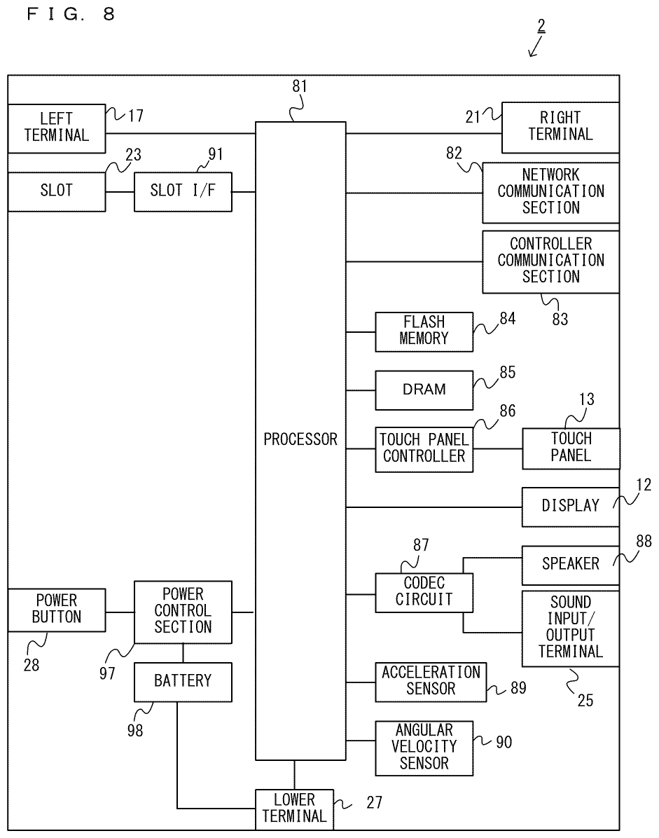

FIG. 8 is a block diagram showing an example of the internal configuration of the main body apparatus 2. The main body apparatus 2 includes components 81 to 91, 97, and 98 shown in FIG. 8 in addition to the components shown in FIG. 5. Some of the components 81 to 91, 97, and 98 may be mounted as electronic components on an electronic circuit board and housed in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various kinds of data (or programs) to be saved in the main body apparatus 2. The DRAM 85 is a memory used to temporarily store various kinds of data used for information processing.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined method for communication (e.g., communication based on a unique protocol or infrared light communication). The wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of players can simultaneously provide inputs to the main body apparatus 2, each using a set of the left controller 3 and the right controller 4. As an example, a first player can provide an input to the main body apparatus 2 using a first set of the left controller 3 and the right controller 4, and simultaneously, a second player can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). On the basis of a command from the processor 81, the power control section 97 controls the supply of power from the battery 98 to the above components.

Further, the battery 98 is connected to the lower terminal 27. When an external charging device (e.g., the cradle) is connected to the lower terminal 27 and power is supplied to the main body apparatus 2 via the lower terminal 27, the battery 98 is charged with the supplied power.

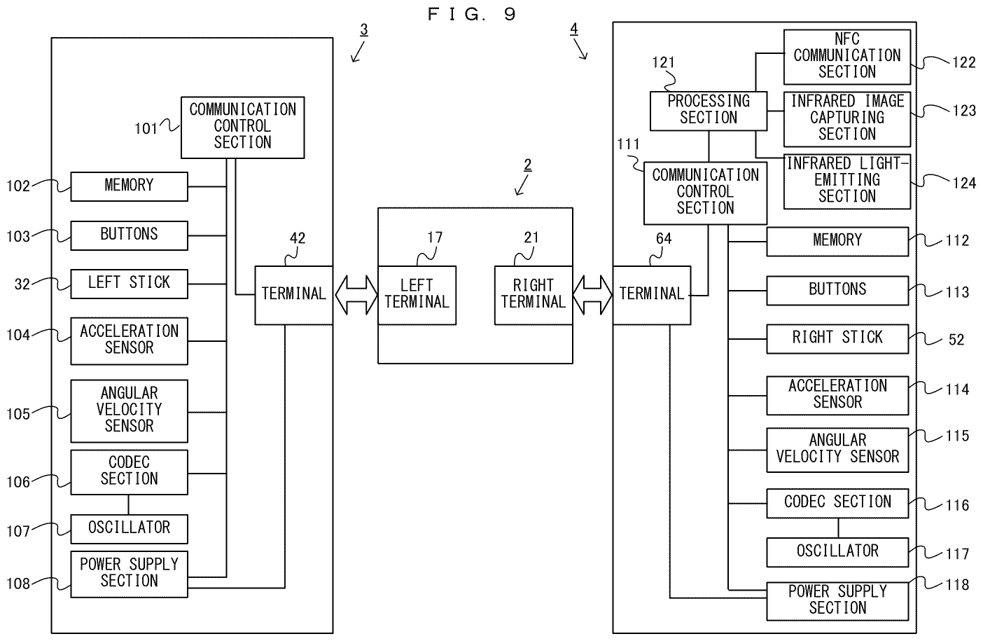

FIG. 9 is a block diagram showing examples of the internal configurations of the main body apparatus 2, the left controller 3, and the right controller 4. The details of the internal configuration of the main body apparatus 2 are shown in FIG. 8 and therefore are omitted in FIG. 9.

The left controller 3 includes a communication control section 101, which communicates with the main body apparatus 2. As shown in FIG. 9, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104. Further, the left controller 3 includes an angular velocity sensor 105. In the exemplary embodiment, the acceleration sensor 104 detects the magnitudes of accelerations along predetermined three axial (e.g., x, y, z axes shown in FIG. 6) directions. The acceleration sensor 104 may detect an acceleration along one axial direction or accelerations along two axial directions. In the exemplary embodiment, the angular velocity sensor 105 detects angular velocities about predetermined three axes (e.g., the x, y, z axes shown in FIG. 6). The angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. The operation data is transmitted repeatedly, once every predetermined time. The interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

The left controller 3 includes a power supply section 108. In the exemplary embodiment, the power supply section 108 includes a battery and a power control circuit. Although not shown in FIG. 9, the power control circuit is connected to the battery and also connected to components of the left controller 3 (specifically, components that receive power supplied from the battery).

As shown in FIG. 9, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, the right stick 52, and inertial sensors (an acceleration sensor 114 and an angular velocity sensor 115). These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### Outline of Information Processing in Exemplary Embodiment

Next, an outline of operation of the information processing according to the exemplary embodiment will be described. In the exemplary embodiment, a description will be given assuming game processing described below as an example of the information processing. A game assumed in the exemplary embodiment is a time attack type game. In this game, a plurality of various kinds of games called “competitions” are prepared. A clear condition is set for each competition, and this game is a game in which users compete for the time from the start of a competition to the time when the clear condition for the competition is achieved (hereinafter referred to as “clear time”). In other words, this game is a game in which such a clear time is evaluated. This evaluation is a process of, for example, presenting a clear time in comparison with past records, determining rankings based on clear times if there are opponents, etc.

The above “competition” will be described more specifically. First, in the exemplary embodiment, the various kinds of games realized as competitions are executed using an emulator program. That is, in the exemplary embodiment, the emulator program is executed to emulate predetermined game processing executed by a predetermined game apparatus. The predetermined game apparatus is an existing game apparatus different from the above game apparatus 1, and in the exemplary embodiment, a game apparatus with an 8-bit CPU is assumed as an example of this predetermined game apparatus. Hereinafter, this game apparatus is referred to as emulation target game apparatus. Here, the game apparatus 1 assumed in the exemplary embodiment is higher in processor performance and image processing performance than the emulation target game apparatus. The game to be emulated (hereinafter referred to as the “emulation target game”) is originally an existing game for the emulation target game apparatus. A medium of game software is provided as a cartridge, a disc, or the like as an example. In the exemplary embodiment, a plurality of emulation target games are used. In the exemplary embodiment, data for each emulation target game is stored in the above DRAM 35 as a game ROM 324 described later. Then, the game ROM 324 is read on the emulator program, and a game program included in the game ROM 324 is executed, whereby each emulation target game is executed. Moreover, in the exemplary embodiment, for executing each emulation target game, the correspondence between predetermined buttons of the above controller and various buttons of a controller of the emulation target game apparatus is predefined. For example, an input of the A-button 53 of the right controller 4 is treated as an input of an A-button of the controller of the emulation target game apparatus.

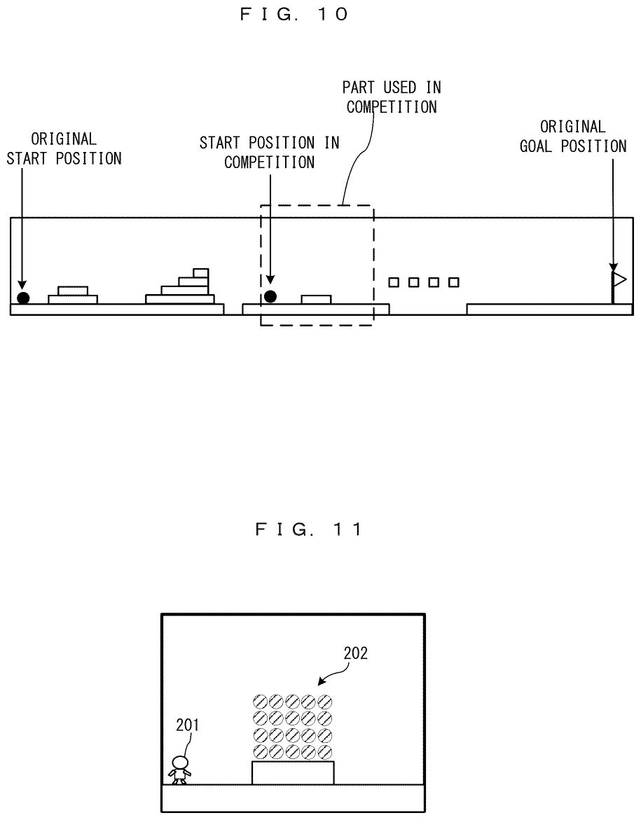

The game executed as a competition uses a part of the above emulation target game. For example, it is assumed that the emulation target game is a side-scrolling type action game. One of a plurality of stages included in the game has a stage structure shown in FIG. 10. In the exemplary embodiment, the competition may use only a part of the stage, for example, a part around substantially the center of the stage in FIG. 10. FIG. 11 shows an example of a screen for the competition. FIG. 11 shows a game image related to a part of the stage, and also shows a scene where a player character (hereinafter abbreviated as PC) 201 and a plurality of items 202 are displayed. As the competition using this scene, a game for competing for the time until all of the plurality of items 202 are acquired, is provided. Therefore, processing related to the competition is processing of causing the emulator to read, for example, a game state corresponding to the scene in FIG. 11, and start emulation from this time point. That is, the competition starts from the scene in the middle of the stage as shown in FIG. 11, not from the beginning of the stage. In this example, this game state is a state that is the state of a memory of the emulation target game apparatus at a predetermined timing and is stored as data (hereinafter referred to as “competition start data”). In the following description, the memory of the emulation target game apparatus reproduced on the DRAM 85 of the game apparatus 1 is referred to as emulator memory. In addition, the scene that is based on the competition start data and is for starting the competition is referred to as “competition start scene”.

As another example of the stage used for a competition, the entirety of one stage out of the plurality of stages may be used. In addition, for example, a competition including multiple stages may be executed. For example, in the case where the emulation target game includes a total of eight stages, the competition may be a competition that uses only a second stage and a third stage.

For determination as to achievement of the above clear condition, various conditions can be set depending on the competition. In the example in FIG. 11, whether all of the plurality of items 202 are acquired is determined, for example, by monitoring a specific address in the above emulator memory. The specific address is, for example, an address in which a value that can change in response to all of the plurality of items 202 being acquired is stored. If the value in the specific address becomes a value indicating that all of the plurality of items 202 have been acquired, it is determined that the clear condition has been achieved. Hereinafter, the specific address is referred to as the “clear determination address”. The clear determination address may be a plurality of addresses or a combination of addresses. As described above, in the exemplary embodiment, a competition is executed using a part or one scene of the emulation target game. Then, a game for competing for the time until the clear condition set for each competition is achieved, is provided.

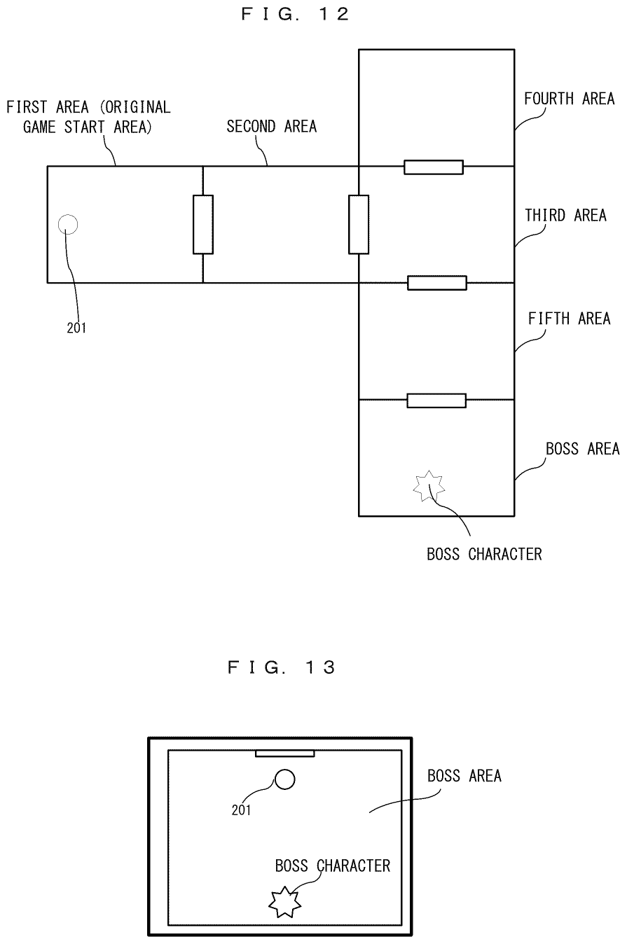

Here, some specific examples of competitions other than the above will be described. First, there is a competition in which the clear condition is to defeat a predetermined enemy character. The enemy character is, for example, a boss character. To give a specific example, an emulation target game that is an action RPG with an overhead view is assumed. The game includes a stage composed of a plurality of areas as shown in FIG. 12, for example. In the stage, game play starts from a first area, and the PC 201 is moved to a boss area, and the stage is cleared by defeating the boss character. In addition, in the game, each area is displayed as one game screen, and when the PC 201 moves between areas, the screen scrolls by area. For example, if the PC 201 reaches the right end of the first area, the screen scrolls to the left end of a second area. As one competition using the emulation target game including such a stage, there is a competition for competing for the time until the boss character is defeated after the competition is started from a time point at which the PC 201 enters the boss area as shown in FIG. 13. In other words, this competition is a competition using only the boss area in the above stage. In this case, a scene immediately after entering the boss area is the above competition start scene.

As one example of the other competitions, there is a competition for competing for the time until reaching a predetermined point in the game stage. In the case of such a competition, for example, it is assumed that a state where the player character is located at a predetermined position in the stage is the above competition start scene. The competition is started from this scene, and a clear condition therefor is that the PC 201 reaches the predetermined point. For example, in the case of the above stage configured as shown in FIG. 12, this competition is a competition for competing for the time until reaching a fourth area with a state where the PC 201 is in the second area as the competition start scene.

As one example of the other competitions, there is a competition for competing for the time until the PC 201 changes into a predetermined state. For example, an emulation target game in which the PC 201 transforms by acquiring a predetermined item in the game is assumed. In such a game, there is a competition for competing for the time until the predetermined item is acquired and transformation is completed after the competition is started from the competition start scene which is a state before the PC 201 transforms.

Here, supplementary description will be given regarding an operation input for an emulator process in the exemplary embodiment. In the exemplary embodiment, as the operation input for the above emulator process, it is also possible to use “operation history information” in addition to operation data outputted from the above controller. The operation history information is data in which the contents of operations by the user are recorded as key log data. As will be described in detail later, in the exemplary embodiment, in game processing described later, the play content of another user for the above competition can be reproduced by executing the emulator process using operation history information of the other user. Then, as will be described later, by displaying an emulator screen in which the play content of the other user and an emulator screen based on the user's own operations in parallel, it is possible to provide a play experience as if the user was competing against the other user in the same competition. In addition, the user's own operation history information can also be used as the operation history information. In this case, an emulator screen in which an own past play content is reproduced can be displayed in parallel, and it is possible to provide a play experience as if the user was competing against themselves in the past.

### [Example of Screen for Competition]

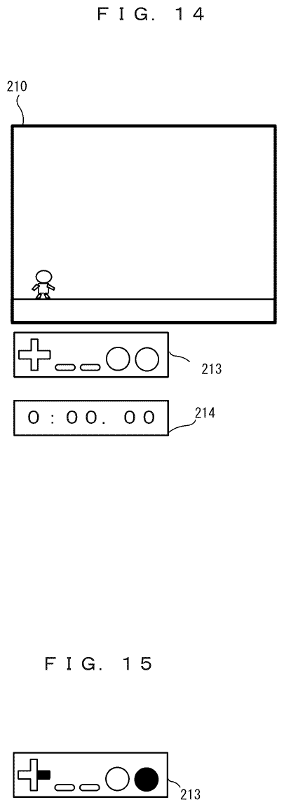

FIG. 14 shows an example of a game screen when playing the emulation target game as the competition. In FIG. 14, an emulator screen 210, an operation information image 213, and elapsed time information 214 are displayed.

The emulator screen 210 is a display area in which a game image based on the processing result of the above emulator is displayed. In the emulator process, when operation data outputted from the controller is used as input, an emulator screen processed based on the operation data is displayed. In addition, when the operation history information is used as input as described above, an emulator screen processed based on the operation history information is displayed.

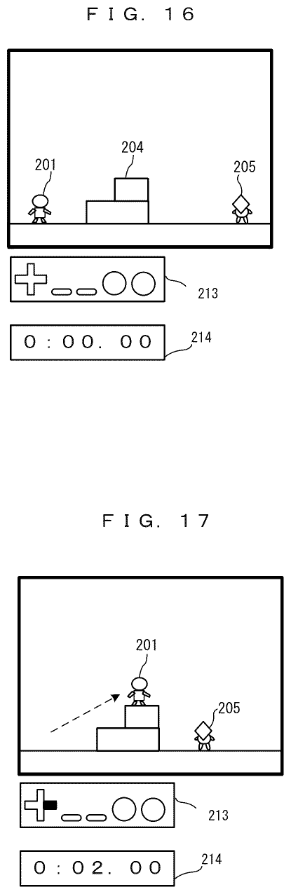

The operation information image 213 is an image imitating the controller of the emulation target game apparatus. The operation information image 213 is an image for visually displaying the content of an operation inputted to the emulator. In the operation information image 213, for example, by changing the display color of a button operated by a 1P user, which key or button is currently being pressed is visually presented to the user. For example, as shown in FIG. 15, in the operation information image 213, by changing the display color or display form of a portion corresponding to a button being pressed, the button being pressed is indicated.

The elapsed time information 214 is a counter that indicates the elapsed time from the start of the competition.

### [Rewind Function]

Here, this game is a game that is for competing for the time until the clear as described above and in which the elapsed time from the start of a competition is counted. In this respect, for example, a competition in which an enemy character appears and a scene where a mistake is made when the PC 201 comes into contact with the enemy character is used, is assumed. This game is a time attack game as described above, but control is performed in which even if a mistake is made, the game is not over, the game state is caused to automatically transition to the state before the mistake occurred, and play is restarted. That is, if the game state becomes a state where the above clear condition for the competition cannot be achieved, such as occurrence of a mistake, control is performed in which the game state is automatically returned to the game state before this state occurred, and the play is continued until the clear condition is achieved. In this example, it is assumed that the emulation target game apparatus does not have such a function. Therefore, this control is performed as a process of a game program that controls the overall game processing according to the exemplary embodiment, including emulator control. In this game, the above elapsed time is measured, including the time taken for the transition of the game state. That is, control is performed in which even if a mistake is made in the middle, the game is automatically started again until the clear condition is achieved, and control is performed in which a clear time is measured, including the time taken for the restart.

Whether the state has become a state where the clear condition cannot be achieved as described above is determined by monitoring a specific address in the above emulator memory as in the case of the above determination for the clear condition. Hereinafter, the address to be monitored is referred to as “return determination address”. The return determination address may be a plurality of addresses. In addition, a process of causing the game state to transition to a previous state is referred to as “state return process”. Moreover, a condition that necessitates execution of the state return process, such as occurrence of the above mistake, is referred to as “restart condition”.

In the exemplary embodiment, the state return process is not started immediately after the restart condition becomes satisfied, but the state return process is started after a predetermined waiting time has elapsed. Here, as the waiting time, a different time may be set depending on the competition. By providing such a waiting time, the user can be more reliably allowed to recognize that the restart condition has been satisfied. That is, if the state return process is started immediately after the restart condition becomes satisfied, depending on the timing and the game situation, it may appear to the user that the state return process has started suddenly, and the user cannot understand why the rewinding has occurred, so that the user may become confused. Therefore, by providing the waiting time as described above, when the restart condition is satisfied, the user is allowed to recognize that the current situation is a situation in which the restart condition has been satisfied, for example, the PC 201 has come into contact with an enemy character and a mistake has occurred.

Hereinafter, an example of operation in the rewind function will be described with reference to FIG. 16 to FIG. 24. Here, a description will be given with a condition that the PC 201 comes into contact with an enemy character, as an example of the restart condition. That is, an example in which the PC 201 comes into contact with an enemy character, and then, after a waiting time has elapsed, the game state is rewound to the state before the contact, will be described. The time point to which the game state is caused to transition as the state return process may differ depending on the emulation target game.

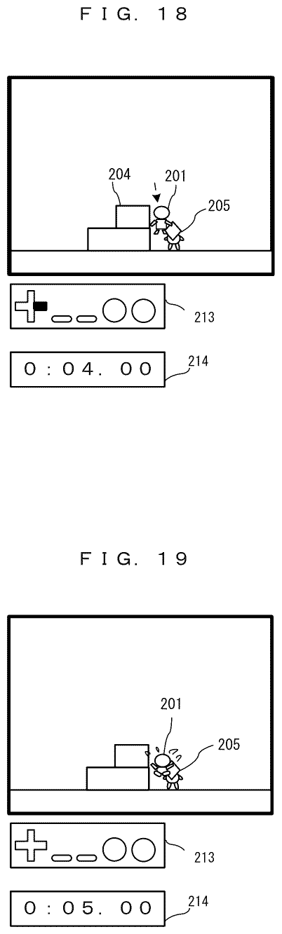

FIG. 16 shows an example of a 1P game screen at the start of a predetermined competition and the elapsed time information 214. In FIG. 16, the PC 201, a terrain object 204, and an enemy character 205 are displayed. It is assumed that, from this state, the PC 201 is moved onto the terrain object 204 as shown in FIG. 17. At this time, the enemy character 205 is also approaching the PC 201. Here, it is assumed that the user wants to cause the PC 201 to jump from the terrain object 204 so as to jump over the enemy character 205. However, it is assumed that the user fails to successfully perform a jump operation and the PC 201 falls from the terrain object 204 and collides with the enemy character 205 as shown in FIG. 18. Due to this collision, a mistake has occurred, which means that the restart condition has been satisfied.

Then, after a predetermined waiting time has elapsed, the state return process is started. In the case where the emulation target game has a specification that a mistake animation is displayed when such collision with an enemy character occurs, a process of reproducing the mistake animation is performed through the emulator process during the waiting time. That is, the emulator process itself is continuously executed even during the waiting time. FIG. 19 shows an example in which such a process of reproducing the mistake animation is executed during the waiting time. Then, after the waiting time has elapsed, the state return process is started. Depending on the length of the set waiting time, the state return process may start in the middle of the mistake animation. In addition, for example, the waiting time may be set in advance such that the state return process is started at the timing when the mistake animation is completed.

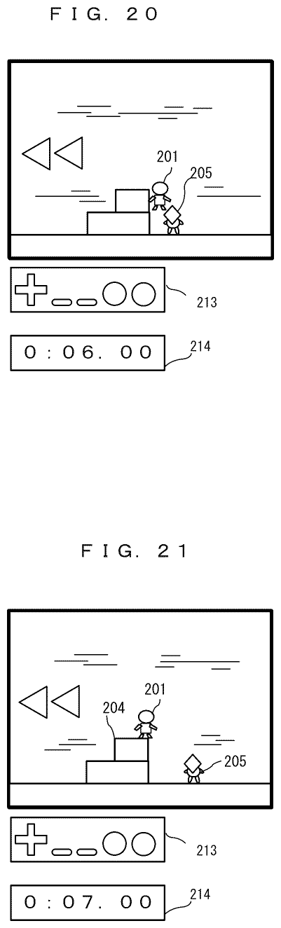

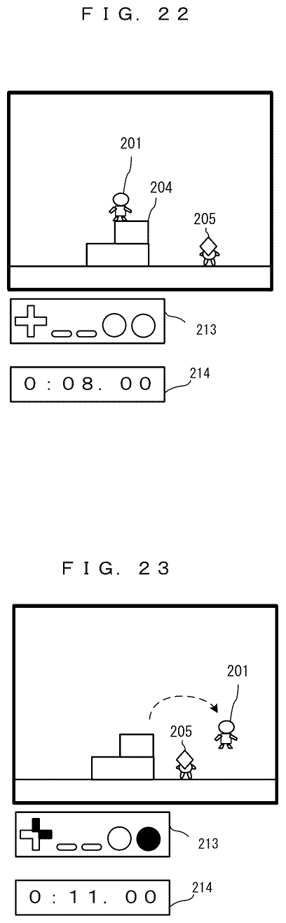

FIG. 20 to FIG. 22 each show an example of a screen during the state return process. In FIG. 20, a reverse reproduction mark and a horizontal line effect image are also shown to indicate that the game state is being caused to transition to a previous state. FIG. 20 shows a state where the game state has transitioned to a state immediately before the PC 201 and the enemy character 205 came into contact with each other. The game state is further caused to transition from this state, and FIG. 21 shows that the game state has transitioned to a state immediately before the PC 201 falls from the terrain object 204. Finally, as shown in FIG. 22, the game state transitions to a state where the PC 201 has just moved to the top of the terrain object 204, and at this time point, the state return process is completed. Also, during such a state return process, an operation on the PC 201 by the user is not accepted. Once the state return process is completed, it becomes possible to accept an operation on the PC 201, and play is restarted. Then, as shown in FIG. 23, the user can continue the competition by performing a jump move in which the PC 201 jumps over the enemy character 205.

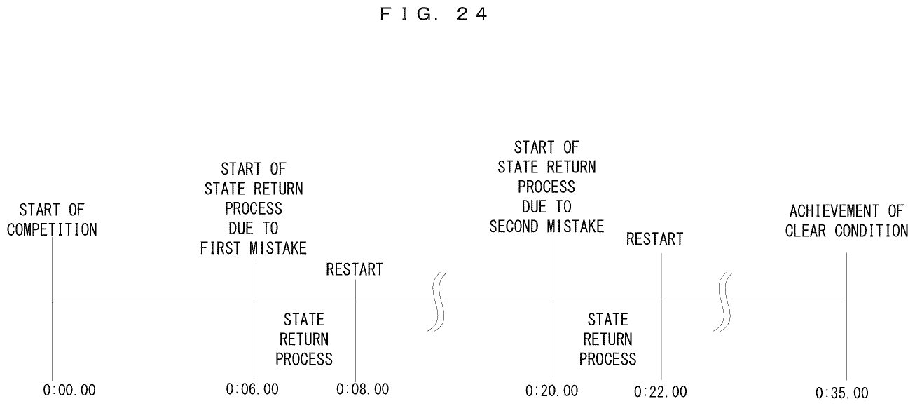

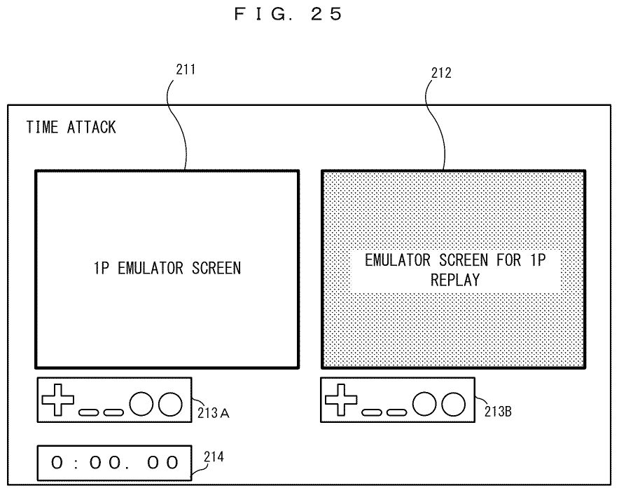

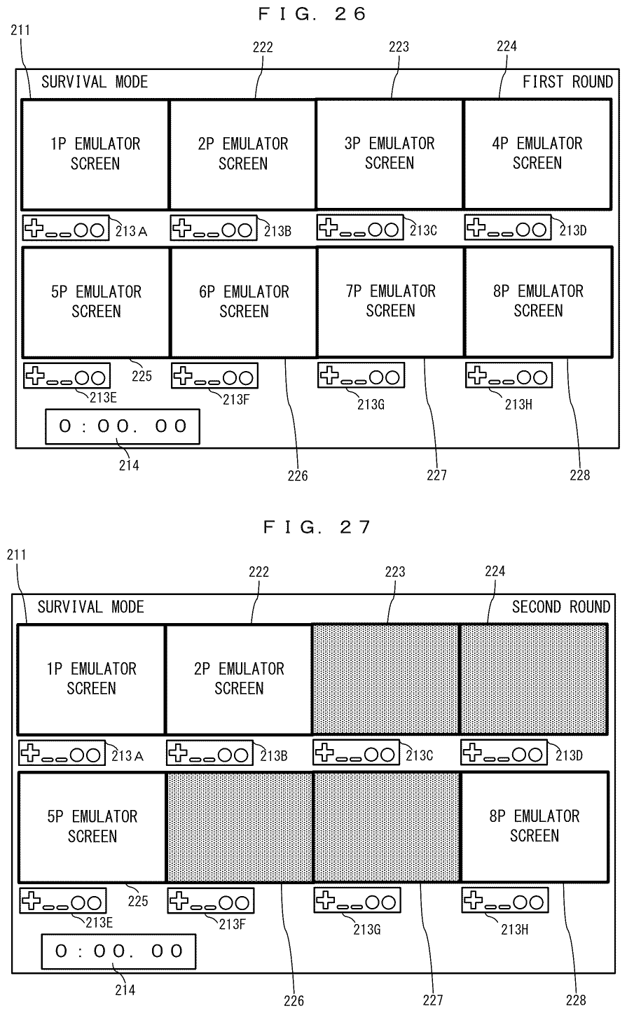

FIG. 24 shows an example of the relationship between the clear time and the state return process. FIG. 24 shows a play in which two mistakes occur before the competition is cleared. In FIG. 24, the state return process is started due to the first mistake at the time point where 6 seconds have elapsed from the start of the competition. The state return process is assumed to take 2 seconds. Then, during the state return process, the elapsed time is also continuously measured (see, for example, FIG. 20 to FIG. 22). Then, play is restarted at 8 seconds after the start of the competition, and at 20 seconds, the state return process is started due to the second mistake. Then, play is restarted at 22 seconds when the state return process is completed, and finally, the clear condition is achieved at 35 seconds. The clear time of 35 seconds includes 4 seconds for the above two state return processes.

The specific method of the above state return process is not limited, and the state return process in this example is performed as follows. In this example, in processing of each frame in the emulator process, the game state, or the state of the emulator memory in the case of this example, is stored for several frames to tens of frames. The number of frames to be stored can vary as appropriate depending on the emulation target game. In the state return process, first, the game processing on the emulator is paused, and then the stored game state is loaded into the emulator memory for one frame at a time in reverse chronological order, and emulator images are displayed sequentially. Accordingly, control is performed in which the play content immediately before the restart condition is satisfied is reversely reproduced and displayed. Then, control is performed in which, if a transition is made to the time point when the emulator process is restarted, the emulator process is restarted.

In the above state return process, as for the speed at which the game state is caused to transition to a previous state (i.e., reverse reproduction speed), the transition to the previous state may be displayed at the same speed as normal play, or may be displayed at a speed different from that of normal play, such as double speed or triple speed. When the transition is displayed at a different multiple-times speed, for example, in the case of double speed, the above stored game state may be loaded while skipping two frames at a time.

As for the restart condition, in addition to the collision with the enemy character 205 described above, there are other conditions described below. For example, if the PC 201 collides with a predetermined object that is different from the enemy character 205 and that causes damage to the PC 201, it may be determined that the restart condition has been satisfied. Alternatively, the PC 201 is provided with a parameter called “physical power value”, and if the physical power value reaches 0 as a result of the PC 201 being damaged, it may be determined that the restart condition has been satisfied. Also, if the PC 201 falls into a pitfall as described later, it may be determined that the restart condition has been satisfied. In addition to the “mistakes”, there are other examples described below. In a competition for which acquiring a predetermined item is an essential condition for clearing the competition, if the PC 201 moves to a position where this item cannot be acquired, it may be determined that the restart condition has been satisfied. Also, for example, in a competition using a scene in which there is a course that branches in the middle, if it is determined that the PC 201 has entered a course or area where the clear condition cannot be achieved, it may be determined that the restart condition has been satisfied. Also, in a competition for which a clear condition is that the PC 201 is in a specific state, if the PC 201 changes from the specific state, it may be determined that the restart condition has been satisfied.

Furthermore, in this example, as the state return process, in addition to the process of returning the game state by one frame at a time as described above, a process of “restart” is also performed depending on the game situation. For example, one of the above restart conditions is that the PC 201 falls into a pitfall and moves outside the stage. If this condition is satisfied, a process of restarting from the competition start scene, without resetting the elapsed time, while continuing to measure the elapsed time is performed. That is, control is performed in which the game state is not returned by one frame at a time but restart is made from the beginning. In addition, at this time, for example, restart may be made over several seconds while a representation in which the screen is darkened is inserted. In this case, the time taken for the representation for the restart is also included in the elapsed time measurement. In addition, if unexpected behavior is made, it may be treated as satisfying the restart condition and restart may be made.

In the following description, as for the mode of the above state return process, a process of returning the game state by a predetermined number of frames at a time is also referred to as “rewind process” and a process of restart from the competition start scene is also referred to as “restart process”.

In addition, for one competition, a plurality of types of restart conditions may be set. For example, for a certain competition, two restart conditions: one for the case of colliding with the enemy character 205 and another for the case of falling into a pitfall, may be set in advance, and the above “return determination address” corresponding to each of these conditions may be defined in advance. Also, as for the mode of the state return process executed when each condition is satisfied, the rewind process and the restart process may be selectively used. For example, in the same competition, the rewind process may be executed when the PC 201 collides with the enemy character 205, and the restart process may be executed when the PC 201 falls into a pitfall.

[Game Modes in this Game]

As described above, the game according to the exemplary embodiment is a time attack type game in which a part of the emulation target game is used for competing for achievement of the clear condition. In the exemplary embodiment, three game modes are prepared for this game. Specifically, the three game modes of (1) a time attack mode, (2) a survival mode, and (3) a contest mode, are prepared. In addition, in the exemplary embodiment, in each mode, the above operation history information of the user is stored and uploaded to the server 1000. Furthermore, in playing each mode, the operation history information corresponding to a competition to be played and stored in the server 1000 is downloaded from the server 1000 as necessary. As described above, by using the operation history information as an operation input in the emulator process, an emulator screen in which the play content of the user themselves in the past or the play content of another user is reproduced can be displayed.

Hereinafter, an outline of each mode will be described.

### [Time Attack Mode]

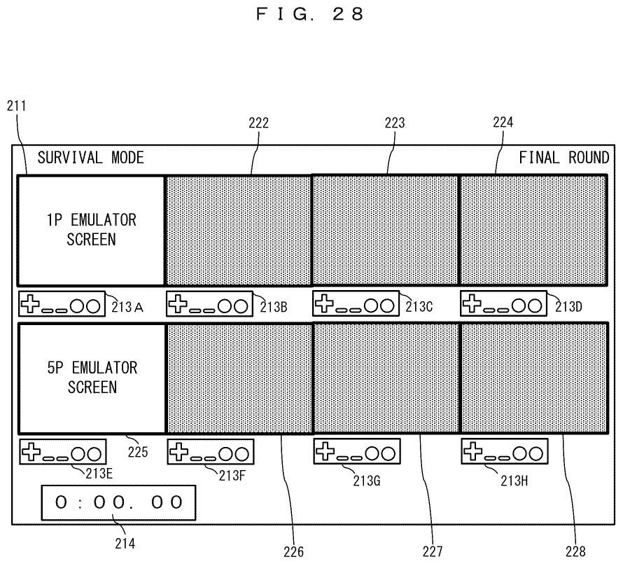

First, the time attack mode (hereinafter abbreviated as TA mode) will be described. The TA mode is a game mode in which a user (hereinafter referred to as 1P user) plays alone, and selects and plays a predetermined competition. FIG. 25 shows an example of a game screen for the TA mode. In FIG. 25, the screen is largely divided into left and right sections, and a 1P emulator screen 211 and an emulator screen (hereinafter referred to as replay screen) 212 based on the operation history information of the 1P user themselves are displayed on the left and right sides, respectively. In the 1P emulator screen 211, a game image based on the processing results of an emulator (hereinafter referred to as 1P emulator) that operates on the basis of an operation input by the 1P user is displayed. The replay screen 212 is based on the processing results of an emulator (hereinafter referred to as 1P replay emulator) that operates on the basis of the operation history information of the 1P user. Therefore, the state in FIG. 25 is a state where processes related to the two emulators, the 1P emulator and the 1P replay emulator, are executed in parallel.

Here, the operation history information of the 1P user is assumed to be operation history information in which the operation of the play (hereinafter referred to as self-best play) in which the best time for the competition to be played is achieved is recorded. That is, in the TA mode, the user is provided with a play experience as if the user was competing against the user themselves when the best record was achieved.

In FIG. 25, operation information images 213A and 213B are displayed below the 1P emulator screen 211 and the replay screen 212, respectively. The operation information image 213A presents the contents of operations by the 1P user. The operation information image 213B presents the contents of operations related to the above self-best play. That is, the display content of the operation information image 213B changes on the basis of the operation history information related to the self-best play.

In the following description, the 1P emulator screen 211 and the operation information image 213A are sometimes collectively referred to as “1P game screen”. The replay screen 212 and the operation information image 213B are sometimes collectively referred to as “1P replay screen”. The entire game screen including the 1P game screen, the 1P replay screen, and the elapsed time information 214 as shown in FIG. 25 above is referred to as “TA mode screen”.

Next, an outline of processing in the TA mode will be described. In the TA mode, the processes related to the two emulators are executed in parallel as described above. The 1P emulator controls the action of the PC 201 on the basis of an operation by the 1P user. The 1P replay emulator controls the action of the PC 201 on the basis of the operation history information related to the self-best play. In starting the competition, the process related to the 1P emulator and the process related to the 1P replay emulator are started simultaneously and executed in parallel. Here, in the exemplary embodiment, since the process related to the 1P emulator and the process related to the 1P replay emulator are started simultaneously and executed in parallel, it is possible to prevent a time lag from occurring between the 1P game screen and the 1P replay screen. Therefore, it is possible to play in a state where it is easy to accurately compare the current own play with the self-best play. In addition, if the clear time is updated as a result of the play, the operation history information treated as the self-best play is also updated.

The 1P replay screen is based on the operation history information of the 1P user, and if a rewind process occurred in the self-best play, the play content of the 1P user including this rewind process is reproduced in the 1P replay screen. As a result, an image related to the above rewind process may also be displayed in the 1P replay screen.

### [Survival Mode]

Next, an outline of the survival mode (hereinafter abbreviated as SV mode) will be described. The SV mode is a game mode in which the 1P user plays a knockout tournament against up to seven opponents, for example. The knockout tournament is a game in which a plurality of types of competitions are one set and the user wins each competition in order, for example, a competition A in the first round, a competition B in the second round, and a competition C in the final round. FIG. 26 to FIG. 28 each show one example of a game screen in the SV mode (hereinafter referred to as SV mode screen). FIG. 26 shows an example of a first-round screen, FIG. 27 shows an example of a second-round screen, and FIG. 28 shows an example of a final-round screen. In FIG. 26, the 1P emulator screen 211 and the operation information image 213A are displayed. In addition, a 2P emulator screen 222 to 8P emulator screen 228 which are emulator screens for the opponents are displayed in the same size as the 1P emulator screen 211. In addition, as for the operation information image 213, operation information images 213B to 213H are displayed for the respective opponents. In the following, the 2P emulator screen 222 to 8P emulator screen 228 and the operation information images 213B to 213H are sometimes collectively referred to as opponent screen. In addition, the elapsed time information 214 is also displayed in the lower left of the screen. In the SV mode, one emulator process is allocated for each opponent. In the case of FIG. 26, eight emulator processes are executed in parallel. FIG. 27 shows a state where the second round is being played by four users who have won the first round. In FIG. 27, in the same screen layout as in FIG. 26, game screens are displayed as the emulator screens for the four users who have won the first round, and the emulator screens for the eliminated users do not show game screens (the emulator processes have been stopped). For the emulator screen for each eliminated user, a predetermined display indicating that the user has been eliminated may be performed. FIG. 28 shows a state where the final round is being played by two users who have won the second round. FIG. 28 also shows that a game screen for each eliminated user is not displayed in the same screen layout as in FIG. 26.

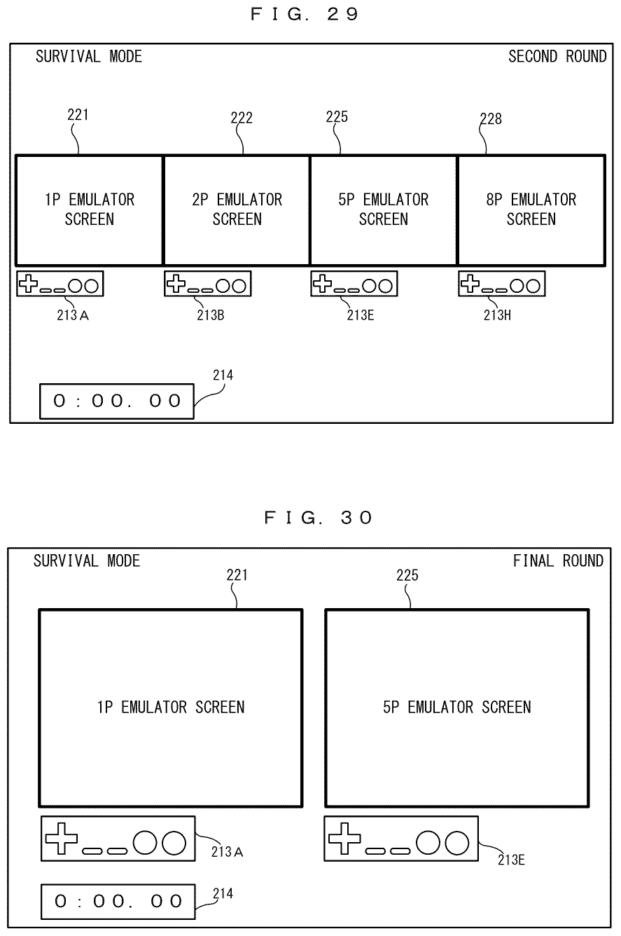

The layout of the respective emulator screens for the second round and the subsequent round may be a layout in which the emulator screen for each eliminated user is not displayed. For example, as for the second round, only the emulator screens for the four users who have won may be displayed in a single horizontal row as shown in FIG. 29. Alternatively, although not shown, these emulator screens may be displayed in a 2×2 layout. In the case of the final round, for example, only the emulator screens for the users who have won the second round may be displayed side by side as shown in FIG. 30. In each of these cases, each emulator screen is displayed in the same size.

### [Opponents in SV Mode]

Here, the opponents in the SV mode will be described. In the SV mode of the exemplary embodiment, the emulator process related to each opponent is performed on the basis of the operation history information of another user downloaded from the server 1000 as described above. As for the downloaded operation history information of the other user, for example, the latest operation history information among the operation history information uploaded to the server 1000 is downloaded and used in the SV mode. In each of the 2P emulator screen 222 to 8P emulator screen 228, an image generated by the emulator process based on the downloaded operation history information is displayed. That is, each opponent in the SV mode can be said to be not a real other user, but rather data for reproducing the player of another user. By using such data to reproduce and display the play content of the other user in parallel with the play of the 1P user, a sense of tension close to that of a real-time online competition is provided. In addition, in the case of the SV mode, if the 1P user wants to play an 8-player competition, it is possible to suppress at least occurrence of a waiting time before opponents are ready, such as waiting for other users to join, and it is possible to quickly start a knockout tournament. Also, during the same knockout tournament, the operation history information of the same opponent is used for each competition included in the knockout tournament. For example, if the operation history information of a user B is used as the opponent, the operation history information of the user B is used for both the first-round competition and the second-round competition. Accordingly, during the knockout tournament, a play experience of competing against the same opponent is provided.

As described above, in the SV mode, for each opponent, an emulator process is performed on the basis of the operation history information of another user. Therefore, as the process of the game program that controls the entire SV mode, the “clear determination address” and the “return determination address” are monitored in each emulator process. In each emulator process, the determination as to the clear described above and the determination as to whether to execute the above state return process are performed. Therefore, in the above opponent screen, an image related to the state return process may also be displayed.

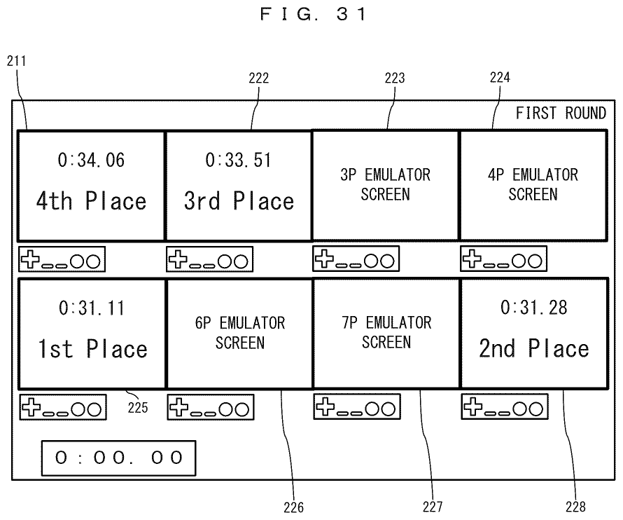

Since the SV mode is a knockout tournament, rankings are determined in order of satisfaction of the clear condition. In the emulator screens in which the clear condition has been satisfied, ranking images are displayed as shown in FIG. 31, for example. FIG. 31 shows a state where rankings up to fourth place have been determined and the remaining four users are still playing. Each ranking image shows the clear time and the ranking. The ranking image is displayed so as to be superimposed on each emulator screen. That is, the ranking image is not displayed as a function of the emulation target game apparatus, but is displayed by the process of the game program that controls the entire SV mode.

In this example, if the 1P user fails to win through to the next round, the 1P user is regarded as being eliminated, and the processing related to the knockout tournament ends at that time. That is, processing that allows the 1P user to watch the final round after being eliminated is not performed. In another exemplary embodiment, the 1P user may be allowed to watch the final round of the knockout tournament even after being eliminated.

### [Contest Mode]

Next, the contest mode will be described. This mode is a mode in which a predetermined competition is played and the result of the play (hereinafter referred to as play record) can be transmitted to the server 1000. Hereinafter, transmitting an own play record to the server 1000 is referred to as “entry”. The play record includes at least the above operation history information, information of a clear time, and information of a user who has transmitted the play record. The play records transmitted to the server 1000 are collected over a predetermined period of time, for example, one week. The collection results for each competition are announced every predetermined period of time, and it is possible to view the collection results in a viewing screen (not shown) in the contest mode.

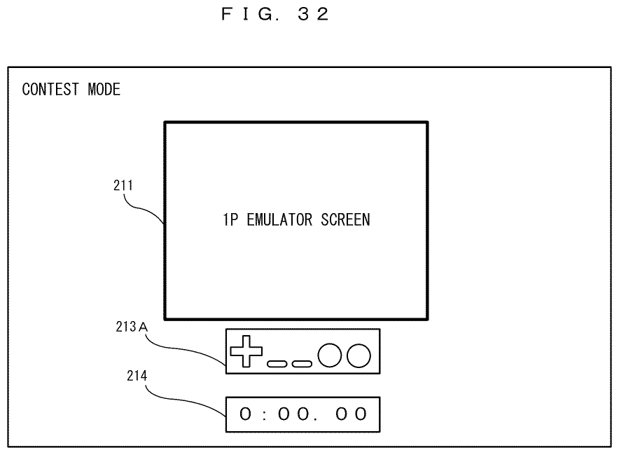

FIG. 32 shows an example of a screen in the contest mode. This screen is an example of a screen for the 1P user to enter a predetermined competition. In FIG. 32, only the 1P game screen in the above TA mode is displayed. Although not shown, before this screen is displayed, a screen for selecting a predetermined competition is displayed, and the 1P user can select a predetermined competition to be entered, from this selection screen. The 1P user plays the predetermined competition on this screen. Then, if the competition is cleared, a play record is generated on the basis of the clear time, and transmitted to the server 1000. In addition, the transmitted play record can be used as an “opponent” in the SV mode executed on another game apparatus 1.

Hereinafter, the processing according to the exemplary embodiment will be described in detail.

Next, various kinds of data used by the server 1000 and the game apparatus 1 and the processing performed by the server 1000 and the game apparatus 1 will be described in detail.

### [Data Used in Server 1000]

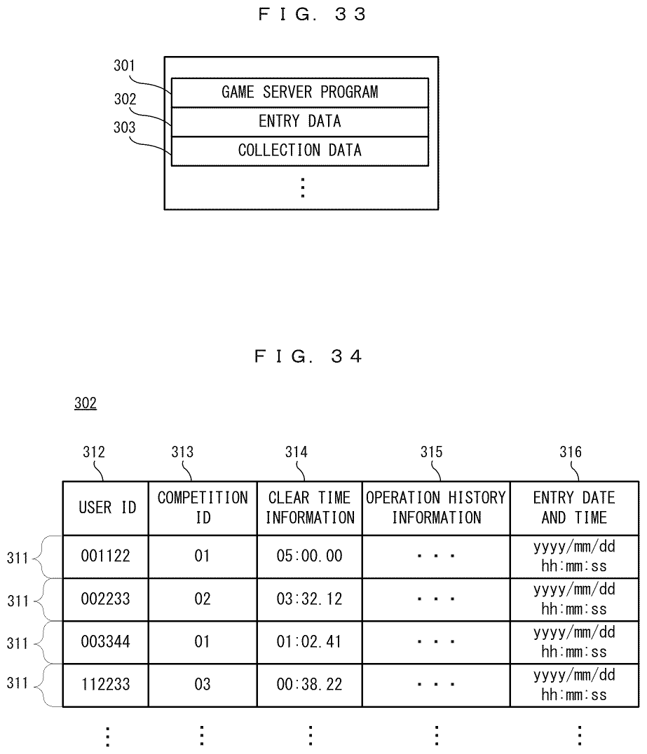

First, the data used in the server 1000 will be described. FIG. 33 illustrates a memory map showing an example of various kinds of data stored in the storage section 1002 of the server 1000. At least a server program 301, entry data 302, and collection data 303 are stored in the storage section 1002 of the server 1000.

The server program 301 is a program for executing server processing including processes of receiving and collecting play records and a process for transmitting operation history information to a predetermined game apparatus 1 for the above SV mode.

The entry data 302 is data in which the play record transmitted from each game apparatus 1 is recorded. FIG. 34 shows an example of the data structure of the entry data 302. The entry data 302 is a database including a plurality of play records 311. Each play record 311 includes at least a user ID 312, a competition ID 313, clear time information 314, operation history information 315, and entry date and time 316. The user ID 312 is an ID for identifying the user who has transmitted the play record. The competition ID 313 is an ID for identifying which competition the play record is for. The clear time information 314 is information indicating the clear time for the competition related to the play record 311. The operation history information 315 is information indicating the history of operations related to the play record 311. The entry date and time 316 is information indicating the date and time when the play record 311 was transmitted to the server 1000.

Referring back to FIG. 33, the collection data 303 is data based on a result of collecting the above play records for each competition. The content of the collection data 303 is updated at a predetermined cycle, for example, on a weekly basis.

### [Data Used in Game Apparatus 1]

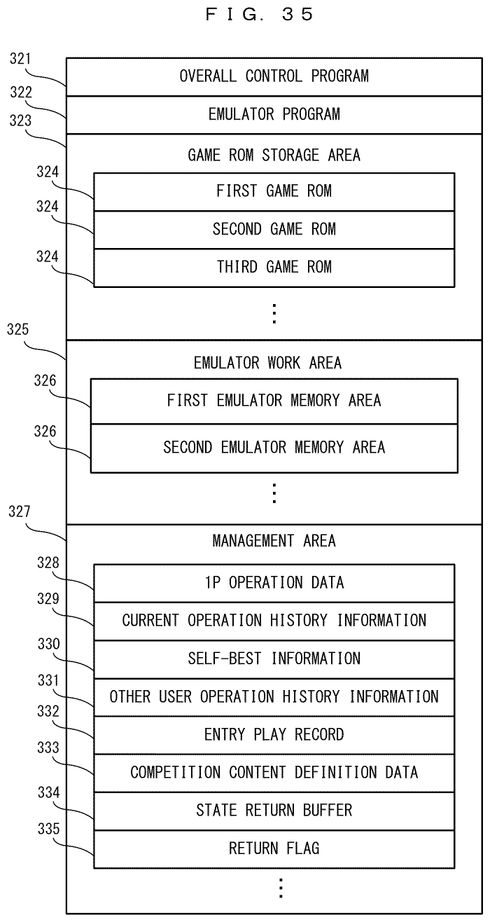

Next, the data used in the game apparatus 1 will be described. FIG. 35 illustrates a memory map showing an example of various kinds of data stored in the DRAM 85 of the game apparatus 1. At least an overall control program 321, an emulator program 322, a game ROM storage area 323, an emulator work area 325, and a management area 327 are stored in the DRAM 85 of the game apparatus 1.

The overall control program 321 is a program for managing and controlling the overall game processing according to the exemplary embodiment including the processing of the TA mode, the SV mode, and the contest mode described above.

The emulator program 322 is a program for emulating the operation of the above emulation target game apparatus.

The game ROM storage area 323 is an area for storing ROM data for the above emulation target game. In the exemplary embodiment, a plurality of game ROMs 324 are stored therein. In addition, each game ROM 324 includes a game program for executing game processing for the emulation target game and game image data. The game program runs on the above virtual emulation target game apparatus that is realized by executing the emulator program 322.

In the emulator work area 325, a plurality of emulator memory areas 326 are stored depending on the number of the plurality of emulators executed simultaneously. Each emulator memory area 326 is a memory space corresponding to the memory installed in the above emulation target game apparatus. In the exemplary embodiment, at the start of execution of the emulator program 322, a process of loading each game ROM 324 is performed, whereby various kinds data included in the game ROM 324 are read into the emulator memory area 326 corresponding to each emulator. In the following description, when the emulator memory area 326 for each emulator is denoted, the emulator memory area 326 is referred to as “nth emulator memory area”. For example, the emulator memory area 326 corresponding to the 1P emulator is referred to as first emulator memory area.

In the management area 327, various kinds of data used in processes other than the emulator process are stored. Specifically, in the management area 327, 1P operation data 328, current operation history information 329, self-best information 330, other user operation history information 331, an entry play record 332, competition content definition data 333, a state return buffer 334, a return flag 335, etc., are stored.

The 1P operation data 328 is data acquired from the controller operated by the 1P user. That is, the 1P operation data 328 is data indicating the contents of operations performed by the 1P user.

The current operation history information 329 is data in which the contents of operations by the 1P user for the competition currently being played are recorded.

The self-best information 330 is data in which the clear time related to the self-best play of the 1P user and the operation history information at this time (hereinafter referred to as self-best operation history) are stored for each competition.

The other user operation history information 331 is data to be used as the operation history information of each opponent in the above SV mode. The other user operation history information 331 is downloaded from the server 1000 and stored at a predetermined timing.

The entry play record 332 is the above play record to be transmitted to the server 1000 in the above contest mode.

The competition content definition data 333 is data that defines the contents of the various competitions described above. Specifically, the competition content definition data 333 includes outline information, start scene information, clear condition information, and restart-related information. The outline information includes information for specifying an emulation target game used for a competition and information for specifying a scene used for the competition. In addition, the start scene information includes data of the game state corresponding to the above competition start scene (hereinafter referred to as competition start scene data). The clear condition information includes information of the above clear condition and “clear determination address”. The restart-related information includes the following information. First, information of the above “return determination address” is included. In addition, information that defines one or more of the above restart conditions and information that specifies the mode of the state return process corresponding to each restart condition are included. Moreover, information indicating the above waiting time until the state return process is actually restarted after the restart condition is satisfied is also included. Moreover, information indicating the number of frames of the game state to be stored in order to perform the above rewind process, that is, information indicating up to which point rewinding is to be performed when the rewind process is performed (hereinafter referred to as return frame count information), is also included.

The state return buffer 334 is an area for temporarily storing game states to be used when the rewind process is performed as the above state return process. In the state return buffer 334, the current game state to the game state previous therefrom by a predetermined number of frames are stored. The capacity of the state return buffer 334 may be determined on the basis of the above return frame count information.

The return flag 335 is a flag for indicating whether or not to execute the above state return process in the processing described below.

Next, a flowchart example of the game processing in the exemplary embodiment will be described.

### [Details of Processing Executed by Processor 81 of Game Apparatus 1]

First, the processing performed by the game apparatus 1 will be described. As described above, this game has three game modes, the TA mode, the SV mode, and the contest mode, and the processing corresponding to each mode is started by the 1P user selecting an item corresponding to each mode from a predetermined menu screen (not shown). Hereinafter, the processing of each mode will be described in detail in the order of the TA mode, the SV mode, and the contest mode.

[Details of TA mode processing]

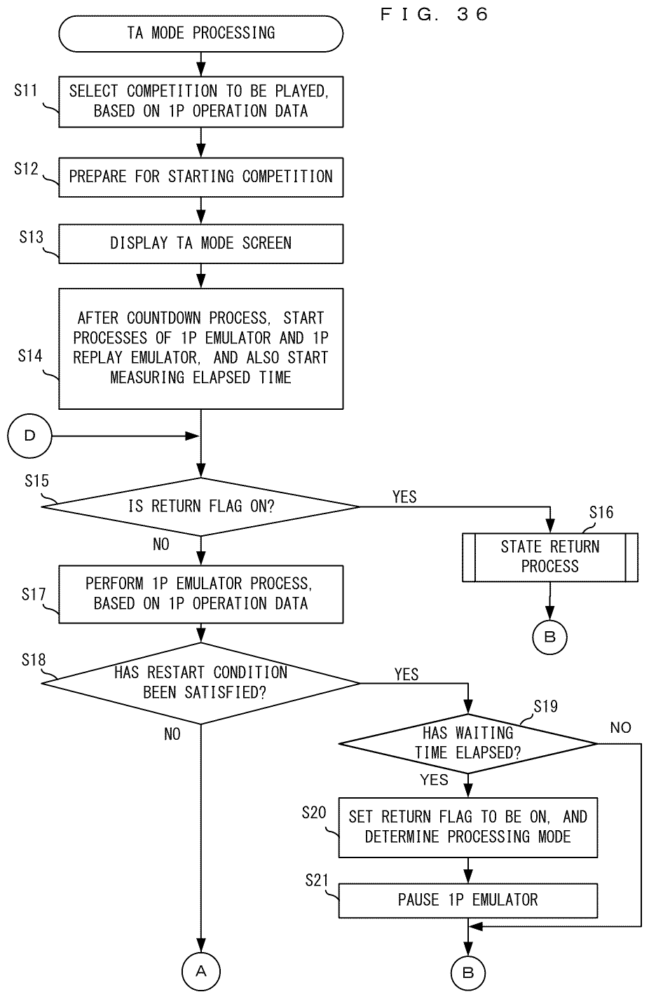

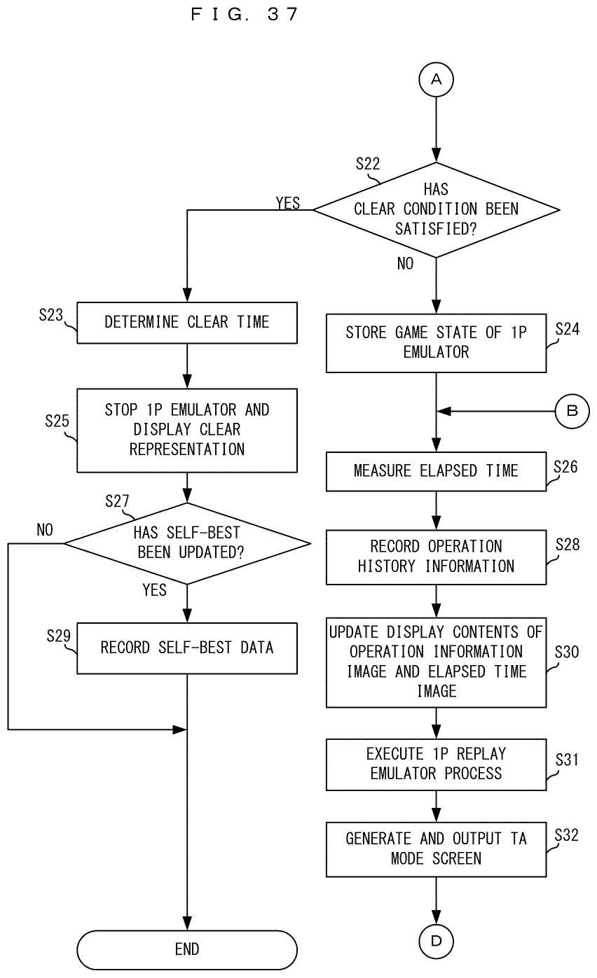

FIG. 36 and FIG. 37 are flowcharts showing the details of the TA mode processing. First, in step S11, the processor 81 displays a competition selection screen which is not shown, and selects a competition to be played this time on the basis of the 1P operation data 328.

Next, in step S12, the processor 81 performs preparation for starting the selected competition. Specifically, the processor 81 ensures a first emulator memory area corresponding to the 1P emulator and a second emulator memory area corresponding to the 1P replay emulator. Next, the processor 81 loads the data of the game ROM 324 related to the competition into each emulator memory area 326. Next, the processor 81 acquires the competition start scene data, the clear condition information, and the restart-related information corresponding to the selected competition from the competition content definition data 333. Furthermore, the processor 81 sets the capacity of the state return buffer 334, etc., as appropriate on the basis of the return frame count information included in the restart-related information. Moreover, the processor 81 acquires the self-best operation history corresponding to the competition from the self-best information 330. Moreover, the processor 81 loads the competition start scene data into each emulator memory area 326, and sets the state of the emulation target game as the game state of the competition start scene. At this time, the operation of the emulator is stopped. Then, the processor 81 generates a 1P emulator screen 111 and a self-best screen 112 related to the above competition start scene.

Next, in step S13, the processor 81 generates a TA mode screen including the above operation information image 213A and the above elapsed time information 214, and outputs the TA mode screen to the display 12.

Next, in step S14, the processor 81 displays a countdown representation (not shown) for starting the competition. Furthermore, after the end of the countdown, the processor 81 starts a process related to the 1P emulator (hereinafter referred to as 1P emulator process) and a process related to the 1P replay emulator (hereinafter referred to as 1P replay emulator process). Moreover, the processor 81 starts recording the operation history information of the 1P user and measuring the elapsed time. Accordingly, the competition is started.

Next, in step S15, the processor 81 determines whether or not the return flag 335 is ON. If, as a result of the determination, the return flag 335 is OFF (NO in step S15), in step S17, the processor 81 acquires the 1P operation data 328. Then, the processor 81 executes the 1P emulator process on the basis of the operation content indicated by this data. Accordingly, the 1P emulator screen 111 is generated. In addition, the processor 81 records the content of the 1P operation data 328 in the current operation history information 329.

Next, in step S18, the processor 81 determines whether or not the above restart condition has been satisfied, on the basis of the value of the above “return determination address”. If, as a result of the determination, the restart condition has not been satisfied (NO in step S18), in step S22 in FIG. 37, the processor 81 determines whether or not the clear condition for the competition has been satisfied, on the basis of the value of the “clear determination address”. If, as a result of the determination, the clear condition has not been satisfied (NO in step S22), in step S24, the processor 81 stores the game state of the 1P emulator at this time, in the state return buffer 334.

Next, in step S26, the processor 81 continues to measure the elapsed time. Next, in step S28, the processor 81 records the operation content indicated by the 1P operation data 328, in the current operation history information 329.

Next, in step S30, the processor 81 updates the display content of the operation information image 213A on the basis of the 1P operation data 328. Furthermore, the processor 81 also updates the display content of the elapsed time information 214.

Next, in step S31, the processor 81 executes the 1P replay emulator process. Specifically, the processor 81 causes the PC 201 in the 1P replay emulator to move on the basis of the above self-best operation history, and executes various kinds of game processing associated with this. In addition, at this time, the processor 81 also determines whether or not the above restart condition has been satisfied in the 1P replay emulator. If the restart condition has been satisfied, the processor 81 performs a state return process described later, targeting the 1P replay emulator. The processor 81 also determines whether or not the clear condition has been satisfied. If the clear condition has been satisfied, the processor 81 stops the 1P replay emulator. At this time, the processor 81 also performs setting for superimposing and displaying the clear time on the self-best screen. Then, the processor 81 generates the self-best screen 112 on the basis of the results of these processes.

Next, in step S32, the processor 81 generates the above TA mode screen and outputs the TA mode screen to the display 12. Then, the processor 81 returns to step S15 above and repeats the processing.

Next, processing performed if, as a result of the determination in step S18 above, the above restart condition has been satisfied (YES in step S18) will be described. In this case, in step S19, the processor 81 determines whether or not the above waiting time defined in the above restart-related information has elapsed after the restart condition is satisfied. If the waiting time has not elapsed (NO in step S19), the processor 81 advances the processing to step S26 above. On the other hand, if the waiting time has elapsed (YES in step S19), in step S20, the processor 81 sets the return flag 335 to be ON. Furthermore, the processor 81 determines the processing mode of the state return process on the basis of the above restart-related information. In this example, either the rewind process or the restart process described above is determined.

Next, in step S21, the processor 81 pauses the progress of the 1P emulator process. Then, the processor 81 advances the processing to step S26 above.

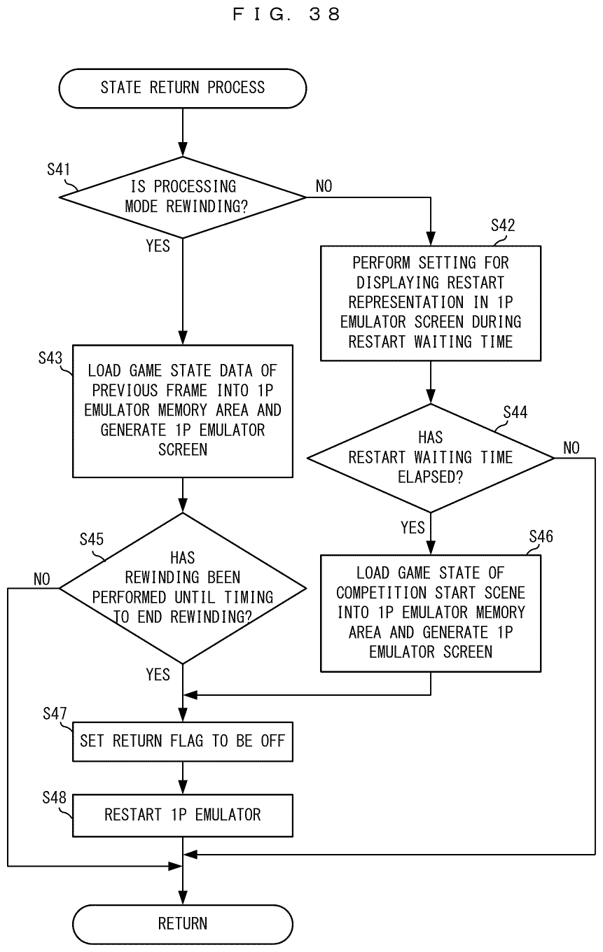

Next, processing performed if, as a result of the determination in step S15 above, the return flag 335 is ON (YES in step S15) will be described. In this case, in step S16, the processor 81 executes the state return process. FIG. 38 is a flowchart showing the details of the state return process. First, in step S41, the processor 81 determines whether or not the processing mode of the state return process determined in step S20 above is the rewind process. If, as a result of the determination, the processing mode is the rewind process (YES in step S41), in step S43, the processor 81 refers to the state return buffer 334 and loads the game state previous from the current game state by one frame, into the 1P emulator memory area. Then, the processor 81 generates a 1P emulator screen based on this state.

Next, in step S45, the processor 81 determines whether or not the game state has been rewound until the timing to end the rewind process. This timing is determined on the basis of the above return frame count information, for example. If, as a result of the determination, the game state has been rewound until the timing to end the rewind process (YES in step S45), in step S47, the processor 81 sets the return flag 335 to be OFF. Furthermore, in step S48, the processor 81 restarts the paused 1P emulator process. Then, the state return process ends.

On the other hand, if the timing to end the rewind process has not been reached (NO in step S45), the processes in steps S47 and S48 are skipped, and the state return process ends.

On the other hand, if, as a result of the determination in step S41 above, the processing mode of the state return process determined in step S20 above is not the rewind process (NO in step S41), the restart process is executed. First, in step S42, the processor 81 performs setting for displaying a restart representation in the 1P emulator screen 111 during a predefined waiting time until restart (hereinafter referred to as restart waiting time). The restart representation is, for example, a representation in which the screen is darkened during the restart waiting time.

Next, in step S44, the processor 81 determines whether or not the restart waiting time has elapsed. If the restart waiting time has not elapsed (NO in step S44), the processor 81 ends the state return process. On the other hand, if the restart waiting time has elapsed (YES in step S44), in step S46, the processor 81 loads the competition start scene data into the 1P emulator memory area and generates the 1P emulator screen 111. Accordingly, a screen showing the PC 201 in the competition start scene is displayed. Then, the processor 81 advances the processing to step S47 above.

Referring back to FIG. 36, after the state return process ends, the processor 81 advances the processing to step S26 above.

Next, processing performed if, as a result of the determination in step S22 above, the clear condition has been satisfied (YES in step S22) will be described. In this case, first, in step S23, the processor 81 stops measuring the elapsed time and determines the clear time for the current competition. In addition, the processor 81 also stops recording the operation history information. Next, in step S25, the processor 81 stops the 1P emulator process. Furthermore, the processor 81 displays a clear representation, for example, such that the clear representation is superimposed on the 1P emulator screen.

Next, in step S27, the processor 81 compares the self-best information 330 with the current clear time determined above, and determines whether or not the self-best clear time has been updated. If, as a result of the determination, the self-best clear time has been updated (YES in step S27), in step S29, the processor 81 updates the content of the self-best information 330 with the clear time for the current competition and the operation history information. At this time, the processor 81 may ask the 1P user whether or not to transmit the current record to the server 1000. Then, if the 1P user instructs the processor 81 to transmit the current record, the processor 81 may transmit the above operation history information, etc., to the server 1000. On the other hand, if the self-best clear time has not been updated (NO in step S27), the process in step S29 above is skipped. Then, the processor 81 ends the TA mode processing.

### [SV Mode Processing]

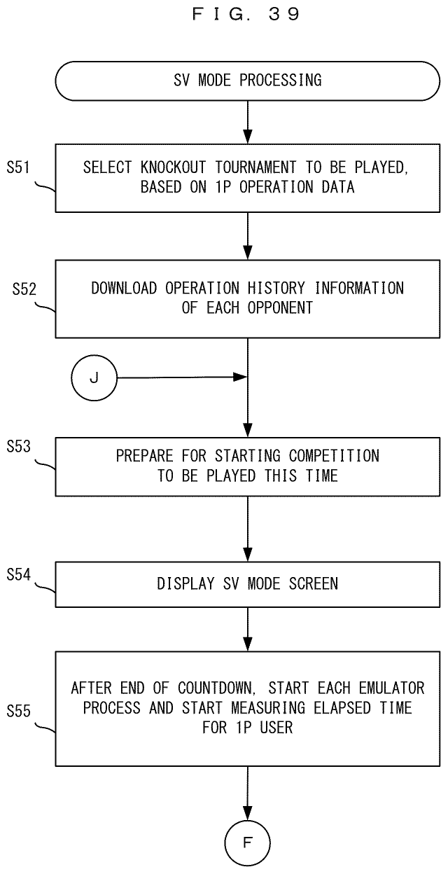

Next, the SV mode processing will be described in detail. FIG. 39 to FIG. 41 are flowcharts showing the details of the SV mode processing. In the flowcharts, some processes are the same as in the above TA mode processing. Therefore, the same processes are designated by the same reference characters, the detailed description thereof is omitted, and the differences from the TA mode processing will be mainly described here.

In FIG. 39, first, in step S51, the processor 81 displays a knockout tournament selection screen which is not shown, and selects a knockout tournament to be played this time, on the basis of the 1P operation data 328.

Next, in step S52, the processor 81 requests the operation history information of each opponent in the SV mode from the server 1000. The server 1000 selects the operation history information of each opponent in response to the request. Then, the processor 81 downloads the operation history information selected by the server 1000. The downloaded operation history information is stored in the DRAM 85 as the other user operation history information 331.

In the exemplary embodiment, the example in which the operation history information is downloaded in step S52 above is shown, but the timing to download the operation history information is not limited thereto. For example, in a process of activating the game according to the exemplary embodiment (for example, at a timing such as before a title screen is displayed), the operation history information corresponding to all competitions in the SV mode may be downloaded together in advance from the server 1000 and stored in the DRAM 85. Then, in step S52 above, a process of merely reading the other user operation history information 331 downloaded in advance may be performed.

Next, in step S53, the processor 81 performs preparation for emulator processes for the opponents in the current competition. Specifically, as in the process in step S12 above, the processor 81 ensures the first emulator memory area corresponding to the 1P emulator, and ensures the emulator memory areas 326 according to the number of opponents. Furthermore, the processor 81 loads the data of the game ROM 324 for the current competition, into each emulator memory area 326. Moreover, the processor 81 acquires various kinds of information regarding the current competition from the competition content definition data 333. Then, the processor 81 loads the competition start scene data into each emulator memory area 326 and generates each emulator screen for the competition start scene.

Next, in step S54, the processor 81 generates the above SV mode screen including the above operation information image 213 and the above elapsed time information 214, and outputs the SV mode screen to the display 12.

Next, in step S55, the processor 81 performs a countdown representation for starting the competition, and then starts the 1P emulator process and a process related to the emulator for each opponent (hereinafter collectively referred to as opponent emulator process). Furthermore, the processor 81 also starts measuring the elapsed time.

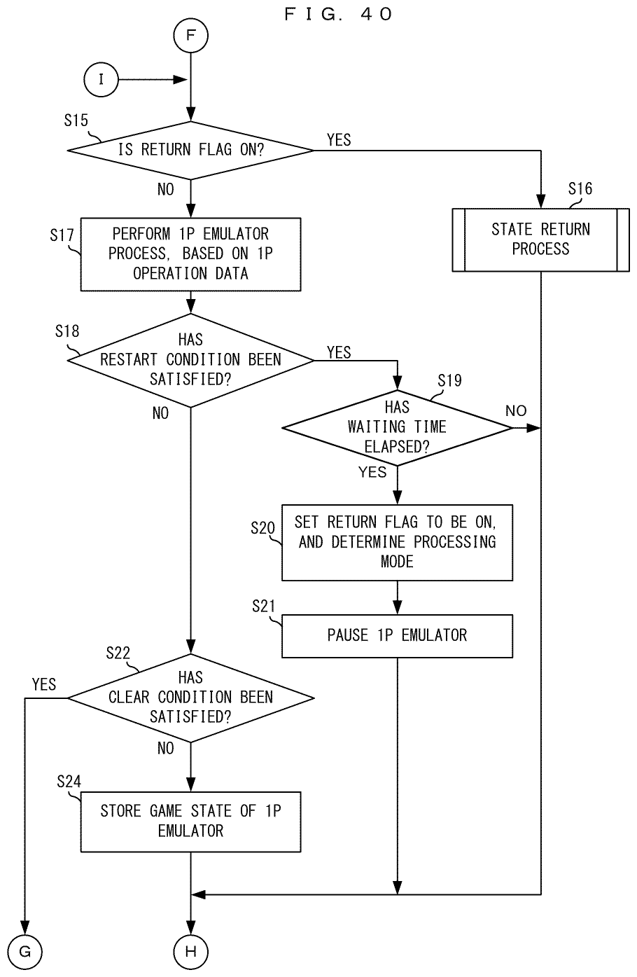

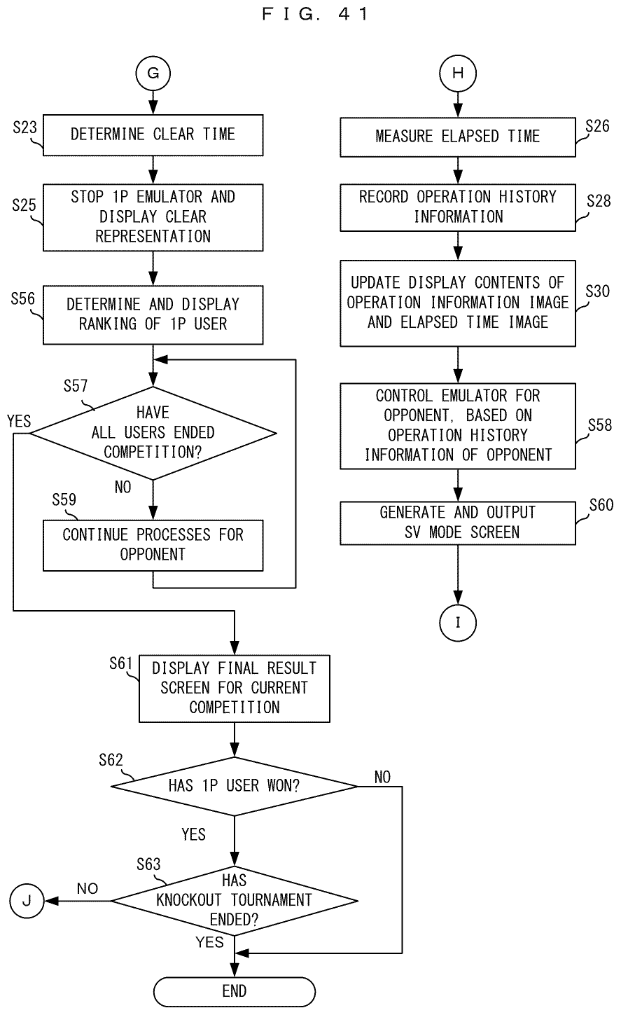

Next, as shown in FIG. 40 and FIG. 41, the processes in steps S15 to S30 above are executed. That is, the process for the 1P user is executed. In the SV mode, operation history of the 1P user may not necessarily be recorded.

Next, after step S30 in FIG. 41, next, in step S58, the processor 81 executes the opponent emulator process on the basis of the operation history information of each opponent. In this process, basically, the same process as in the case of the 1P emulator is performed. Therefore, the above state return process is also executed as necessary. However, in this process, no operation history is recorded and no elapsed time is measured. As a result of the opponent emulator process, an emulator screen for each opponent is generated. In addition, if the clear condition is achieved by the emulator process for an opponent, the processor 81 stops the emulator process for the opponent. Then, the processor 81 also performs setting for superimposing and displaying the above ranking image (see FIG. 31) on the emulator screen for each opponent. The clear time may be displayed on the basis of the other user operation history information 331, or the processor 81 may start measuring the elapsed time for each opponent in the process in step S55 above and display the measured time.

Next, in step S60, the processor 81 generates an SV mode screen including the above emulator screens, and outputs the SV mode screen to the display 12. Then, the processor 81 returns to step S15 above and repeats the processing.

Next, processing performed after step S25 in FIG. 41 will be described. That is, processing after the 1P user achieves the clear condition will be described. After the process in step S25, in step S56, the processor 81 determines the ranking of the 1P user and superimposes and displays the above ranking image on the 1P emulator screen. Next, in step S57, the processor 81 determines whether or not all of the opponents have achieved the clear condition for the current competition. If, as a result of the determination, there is any opponent who has not yet achieved the clear condition (NO in step S57), in step S59, the processor 81 continues the various processes for the opponent until all of the opponents have achieved the clear condition.

On the other hand, if all of the opponents have achieved the clear condition (YES in step S57), in step S61, the processor 81 displays a final result screen showing the final rankings of the current competition, etc.

Next, in step S62, the processor 81 determines whether or not the 1P user has won the current competition (whether the 1P user has won against the opponent in the case of the final round). If, as a result of the determination, the 1P user has not won the current competition (NO in step S62), the processor 81 displays an elimination representation, etc., and then ends the SV mode processing. On the other hand, if the 1P user has won the current competition (YES in step S62), in step S63, the processor 81 determines whether or not all the competitions in the current knockout tournament have ended. If, as a result of the determination, not all the competitions have ended (NO in step S63), the processor 81 returns to step S53 above and executes the above processes for the next competition. On the other hand, if all the competitions have ended (YES in step S63), the processor 81 displays a final result screen for the knockout tournament and then ends the SV mode processing.

### [Contest Mode Processing]

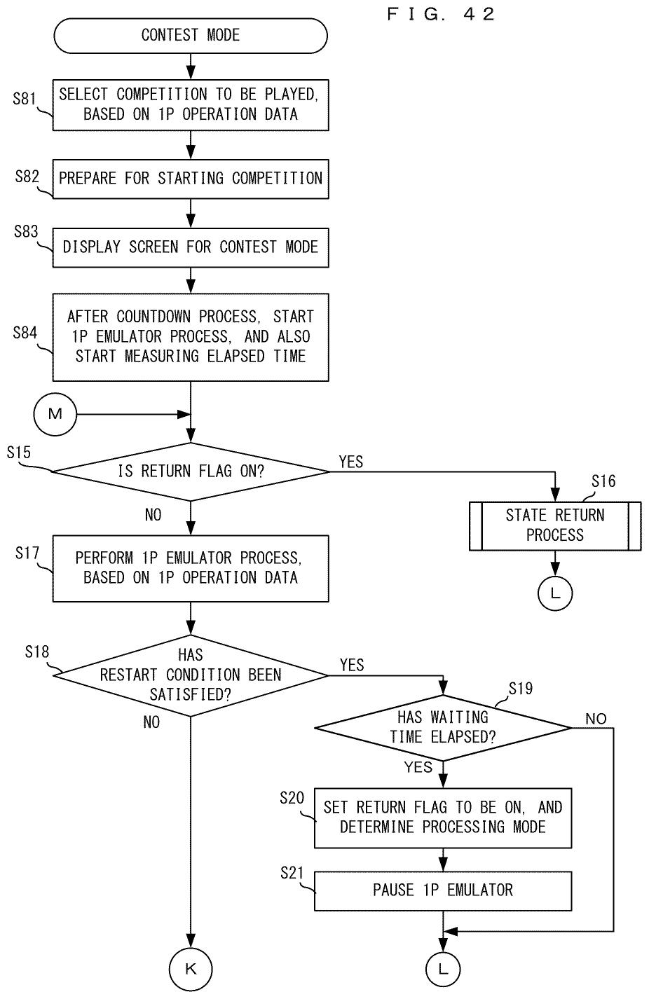

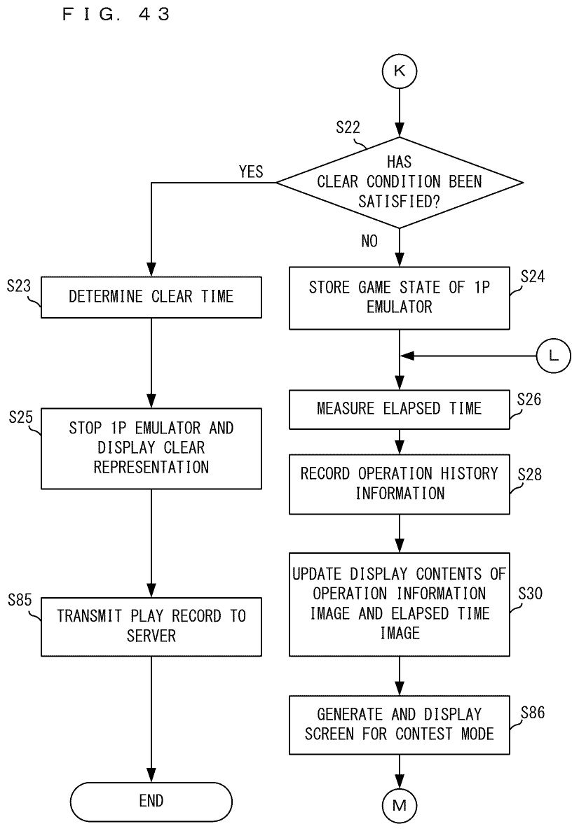

Next, the contest mode processing will be described in detail. FIG. 42 and FIG. 43 are flowcharts showing the details of the contest mode processing. In the flowcharts as well, some processes are the same as in the above TA mode processing. Therefore, the same processes are designated by the same reference characters, the detailed description thereof is omitted, and the differences from the TA mode processing will be mainly described here.

In FIG. 42, first, in step S81, the processor 81 displays a competition selection screen which is not shown, and selects a competition to be played and entered this time on the basis of the 1P operation data 328.

Next, in step S82, the processor 81 performs preparation for starting the competition. Basically, the same process as in step S12 above is performed, but the process related to the self-best screen is omitted here.

Next, in step S83, the processor 81 generates a screen for the contest mode as shown in FIG. 32 above, and outputs the screen to the display 12.

Next, in step S84, the processor 81 performs a countdown representation for starting the competition, and then starts the 1P emulator process. Furthermore, the processor 81 also starts measuring the elapsed time.

Then, various processes for the 1P user are executed in steps S15 to S30. Unlike the TA mode, next to step S30, in step S86, the processor 81 generates a screen for the contest mode, and outputs the screen to the display 12.

In addition, after the 1P user achieves the clear condition and the clear representation is displayed in step S25 above, in step S85, the processor 81 generates an entry play record 332 on the basis of the operation history information and the clear time recorded this time. Then, the processor 81 transmits the entry play record 332 to the server 1000. Then, the processor 81 ends the contest mode processing.

This is the end of the detailed description of the processing related to the game apparatus 1.

### [Processing of Server 1000]

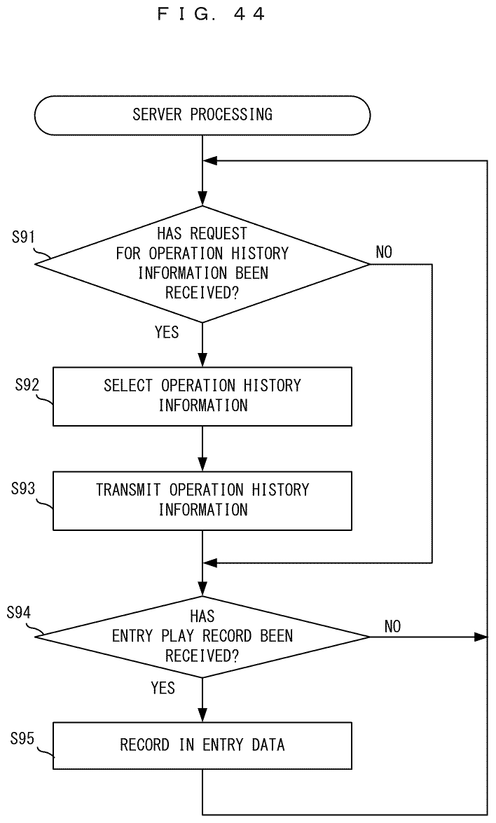

Next, processing executed by the server 1000 will be described in detail. FIG. 44 is a flowchart showing the details of the processing related to the server 1000. In FIG. 44, first, in step S91, the processor 1001 of the server 1000 determines whether or not a request for the operation history information of an opponent in the SV mode has been received from a predetermined game apparatus 1. If such a request has not been received (NO in step S91), the processor 1001 advances the processing to step S94 described later. If such a request has been received (YES in step S91), in step S92, the processor 1001 selects a user to be the opponent. The method of this selection is not limited, and for example, a user who made an entry at a timing close to the timing of receiving the above request may be selected preferentially. Furthermore, the processor 1001 refers to the entry data 302, and selects the operation history information 315 on the basis of the user ID 312 of the selected user and the competition ID 313 of each competition constituting the knockout tournament included in the request. Accordingly, the operation history information of the same user is selected for each round competition of the knockout tournament.

Next, in step S93, the processor 1001 transmits the above operation history information 315 to the game apparatus 1 that has made the request.

Next, in step S94, the processor 1001 determines whether or not the above entry play record 332 has been received. If, as a result of the determination, the entry play record 332 has been received (YES in step S94), in step S95, the processor 1001 registers the received entry play record 332 in the entry data 302. Then, the processor 1001 returns to step S91 above and repeats the processing. If the entry play record 332 has not been received (NO in step S94), the process in step S95 is skipped and the processor 1001 returns to step S91 above. This is the end of the detailed description of the processing related to the server 1000.

As described above, in the exemplary embodiment, game processing is performed using the emulators. In this case, not only the emulator process for the 1P user but also the emulator process using the above operation history information is performed in parallel. The processing results of each emulator are displayed as an individual game image. In addition, as the operation history information, it is possible to use information based on the past play content of the 1P user (TA mode) and information based on the play content of another user (SV mode). In the case of the TA mode, the own past play content is displayed so as to be aligned with the current own play screen, so that it is possible to provide an environment in which it is easy to play while comparing both. In the case of the SV mode, for example, it is possible to avoid a situation in which time is taken to wait for opponents to join an online play via a network, and to quickly start a (pseudo) multi-player competitive game. In addition, in either mode, the game processing for the 1P user and the game processing using the operation history information are started at the same timing, so that it is possible to provide a competitive play in a situation in which no time lag occurs due to a network delay, etc., for example.

In addition, in the SV mode, the emulator screens for the 1P emulator screen and the opponents are displayed in equal sizes. Accordingly, it is possible to provide a sense of realism, as if, for example, an offline game tournament were being held, with eight game machines lined up in the same venue and the game screens of these machines being projected together on a single large monitor for the tournament.

In addition, by displaying the above operation information image 213 indicating the operation content, it is possible to grasp how the 1P user during the self-best play or each opponent is operating the controller. Accordingly, the operation information image 213 can be used as a reference for operations to shorten the clear time.

In addition, in the exemplary embodiment, even if a mistake occurs during a competition, the game is not ended there, the game state is caused to transition to the state before the mistake occurred, and play is continued. In other words, the play for the competition is continued until the clear condition is satisfied. Furthermore, the time taken for the transition of the game state is also included in the clear time measurement. Accordingly, it is possible to provide an environment that enables more appropriate measurement, particularly in a game for competing for time such as a time attack game.

### [Modifications]

In the above embodiment, the example in which the elapsed time information 214 is displayed in each game mode, has been described. However, control may be performed such that the elapsed time information 214 is not displayed.

In addition, the example in which, in the TA mode, the self-best screen is displayed on the basis of the operation history information related to the self-best play, has been described. In another exemplary embodiment, in the TA mode, the operation history information of another user may be used instead of the operation history information related to the self-best play. For example, the operation history information of a user ranked high in the collection result of the contest mode may be downloaded and used. Alternatively, only the replay screen 212 may be displayed, and only reproduction of the play content using the operation history information may be performed.

In addition, in the TA mode, play may be performed with a plurality of types of competitions as one set.

In the above embodiment, when the restart condition is satisfied, the state return process is started after a predetermined waiting time has elapsed, such as waiting for the completion of the reproduction of the above mistake animation. In another exemplary embodiment, depending on the game content, the state return process may be started immediately after the restart condition is satisfied, without providing the waiting time.

As for the operation history information used in the SV mode, for example, the operation history information recorded in each competition in a knockout tournament may be uploaded to the server 1000, and this information may be downloaded and used. That is, in the SV mode, the operation history information may be managed for each knockout tournament. For example, in the case where a knockout tournament A includes a competition B, a competition C, and a competition D, the operation histories of the 1P user for the competition B, the competition C, and the competition D may be recorded in the SV mode, and these operation histories may be transmitted to and stored in the server 1000 as one set. When these operation histories are downloaded to another game apparatus 1, the operation history information of the 1P user for the set of the competition B, the competition C, and the competition D may be downloaded as operation history information related to the knockout tournament A.

In the above embodiment, the case where the above game processing is executed by a single game apparatus 1 has been described. The game apparatus 1 may include a plurality of storages and a plurality of processors. The above game processing may be shared and executed by these storages and processors. The above processing may be executed in a distributed system including at least one server and a plurality of information processing apparatuses.

While the present disclosure has been described in detail, the foregoing description is in all aspects illustrative and not restrictive. It is to be understood that numerous other modifications and variations can be devised without departing from the scope of the present disclosure.

What is claimed is:

1. A game system comprising one or more processors, the one or more processors being configured to:
start a first game;
process the first game, based on an operation input by a user;
generate a game image including a first image based on the first game;
if a game state satisfies a first condition in the first game, cause the game state to transition to a state before the first condition is satisfied; and
if the game state satisfies a second condition in the first game, stop or end processing of the first game.

2. The game system according to claim 1, wherein the one or more processors are configured to store the game state in each frame from a current frame to a frame before a predetermined period in the first game, and cause the game state to transition to a game state in a predetermined frame before the first condition is satisfied, if the first condition is satisfied.

3. The game system according to claim 2, wherein the one or more processors are configured to, if the game state satisfies the first condition, cause the game state to transition to a game state before the first condition is satisfied, by causing the game state to sequentially transition to the game state in each frame to the frame before the predetermined period.

4. The game system according to claim 1, wherein the one or more processors are configured to cause the first game to operate by an emulator.

5. One or more non-transitory computer-readable storage media having stored therein a game program causing one or more processors of a game system to:
start a first game;
process the first game, based on an operation input by a user;
generate a game image including a first image based on the first game;
if a game state satisfies a first condition in the first game, cause the game state to transition to a state before the first condition is satisfied; and
if the game state satisfies a second condition in the first game, stop or end processing of the first game.

6. The one or more non-transitory computer-readable storage media according to claim 5, wherein the game program further causes the one or more processors to measure an elapsed time from the start of the game until the second condition is satisfied, including a time taken for the transition of the game state.

7. The one or more non-transitory computer-readable storage media according to claim 5, wherein the first condition is a condition satisfied when at least one of falling of an operation character acting based on the operation input, damage to the operation character, and entry of the operation character into a location other than a pre-specified location occurs.

8. The one or more non-transitory computer-readable storage media according to claim 5, wherein the game program further causes the one or more processors to store the game state in each frame from a current frame to a frame before a predetermined period in the first game, and cause the game state to transition to a game state in a predetermined frame before the first condition is satisfied, if the first condition is satisfied.

9. The one or more non-transitory computer-readable storage media according to claim 8, wherein the game program further causes the one or more processors to, if the game state satisfies the first condition, cause the game state to transition to a game state before the first condition is satisfied, by causing the game state to sequentially transition to the game state in each frame to the frame before the predetermined period.

10. The one or more non-transitory computer-readable storage media according to claim 8, wherein the game program further causes the one or more processors to, if the game state satisfies the first condition, cause the game state to transition to a game state before the first condition is satisfied, after a predetermined waiting period has elapsed.

11. The one or more non-transitory computer-readable storage media according to claim 5, wherein the game program further causes the one or more processors to, if the game state satisfies the first condition, cause the game state to transition to a game state at the start of the first game.

12. The one or more non-transitory computer-readable storage media according to claim 5, wherein the game program further causes the one or more processors to cause the first game to operate by an emulator.

13. The one or more non-transitory computer-readable storage media according to claim 5, wherein the game program further causes the one or more processors to:
simultaneously start the first game and at least one second game that is the same as the first game and operates based on operation history information that is a history of an operation input;
process the at least one second game, based on at least one piece of the operation history information;
generate the game image including at least one second game image based on the second game;
if the first condition is satisfied in the second game, causes the game state to transition to a game state before the first condition is satisfied; and
if the second condition is satisfied in the second game, stop or end processing of the second game.

14. The one or more non-transitory computer-readable storage media according to claim 13, wherein the game program further causes the one or more processors to store a history of the operation input in the first game as the operation history information.

15. The one or more non-transitory computer-readable storage media according to claim 13, wherein the game program further causes the one or more processors to process the second game, based on the operation history information stored by another game system.

16. The one or more non-transitory computer-readable storage media according to claim 14, wherein the game program further causes the one or more processors to process the second game, based on the operation history information obtained when an elapsed time from the start of the first game until the second condition is satisfied is shortest.

17. The one or more non-transitory computer-readable storage media according to claim 15, wherein the game program further causes the one or more processors to start the first game and the second game next in a predetermined order only if a third condition is satisfied in a series of games in which a plurality of types of the first games and the second games are performed continuously in the predetermined order.

18. The one or more non-transitory computer-readable storage media according to claim 17, wherein the third condition is a condition that, in rankings based on results of end of a predetermined first game and a predetermined second game in the series of games, a ranking based on the result of the end of the first game is within a predetermined ranking.

19. The one or more non-transitory computer-readable storage media according to claim 17, wherein the game program further causes the one or more processors to process the plurality of types of the second games executed in a predetermined order in the series of games, based on the operation history information of the plurality of types of the second games stored by another single game system, respectively.

20. The one or more non-transitory computer-readable storage media according to claim 5, wherein
the game system includes a plurality of game apparatuses including the processors, and at least one server, and
the game program further causes the one or more processors to upload play record data including information of an elapsed time from the start of the first game until the second condition is satisfied in the first game, to the server.

21. A computer implemented method causing one or more processors of a game system to:
start a first game;
process the first game, based on an operation input by a user;
generate a game image including a first image based on the first game;
if a game state satisfies a first condition in the first game, cause the game state to transition to a state before the first condition is satisfied; and
if the game state satisfies a second condition in the first game, stop or end processing of the first game.

22. The computer implemented method according to claim 21, further causing the one or more processors to measure an elapsed time from the start of the game until the second condition is satisfied, including a time taken for the transition of the game state.

23. The computer implemented method according to claim 21, wherein the first condition is a condition satisfied when at least one of falling of an operation character acting based on the operation input, damage to the operation character, and entry of the operation character into a location other than a pre-specified location occurs.

24. The computer implemented method according to claim 21, further causing the one or more processors to store the game state in each frame from a current frame to a frame before a predetermined period in the first game, and cause the game state to transition to a game state in a predetermined frame before the first condition is satisfied, if the first condition is satisfied.

25. The computer implemented method according to claim 24, further causing the one or more processors to, if the game state satisfies the first condition, cause the game state to transition to a game state before the first condition is satisfied, by causing the game state to sequentially transition to the game state in each frame to the frame before the predetermined period.

26. The computer implemented method according to claim 24, further causing the one or more processors to, if the game state satisfies the first condition, cause the game state to transition to a game state before the first condition is satisfied, after a predetermined waiting period has elapsed.

27. The computer implemented method according to claim 21, further causing the one or more processors to, if the game state satisfies the first condition, cause the game state to transition to a game state at the start of the first game.

28. The computer implemented method according to claim 21, further causing the one or more processors to cause the first game to operate by an emulator.

29. The computer implemented method according to claim 21, further causing the one or more processors to:
simultaneously start the first game and at least one second game that is the same as the first game and operates based on operation history information that is a history of an operation input;
process the at least one second game, based on at least one piece of the operation history information;
generate the game image including at least one second game image based on the second game;
if the first condition is satisfied in the second game, causes the game state to transition to a game state before the first condition is satisfied; and
if the second condition is satisfied in the second game, stop or end processing of the second game.

30. The computer implemented method according to claim 29, further causing the one or more processors to store a history of the operation input in the first game as the operation history information.

31. The computer implemented method according to claim 29, further causing the one or more processors to process the second game, based on the operation history information stored by another game system.

32. The computer implemented method according to claim 30, further causing the one or more processors to process the second game, based on the operation history information obtained when an elapsed time from the start of the first game until the second condition is satisfied is shortest.

33. The computer implemented method according to claim 31, further causing the one or more processors to start the first game and the second game next in a predetermined order only if a third condition is satisfied in a series of games in which a plurality of types of the first games and the second games are performed continuously in the predetermined order.

34. The computer implemented method according to claim 33, wherein the third condition is a condition that, in rankings based on results of end of a predetermined first game and a predetermined second game in the series of games, a ranking based on the result of the end of the first game is within a predetermined ranking.

35. The computer implemented method according to claim 33, further causing the one or more processors to process the plurality of types of the second games executed in a predetermined order in the series of games, based on the operation history information of the plurality of types of the second games stored by another single game system, respectively.

36. The computer implemented method according to claim 21, wherein
the game system includes a plurality of game apparatuses including the processors, and at least one server, and
the computer implemented method further causes the one or more processors to upload play record data including information of an elapsed time from the start of the first game until the second condition is satisfied in the first game, to the server.

37. A game apparatus comprising one or more processors, the one or more processors being configured to:
start a first game;
process the first game, based on an operation input by a user;
generate a game image including a first image based on the first game;
if a game state satisfies a first condition in the first game, cause the game state to transition to a state before the first condition is satisfied; and
if the game state satisfies a second condition in the first game, stop or end processing of the first game.

38. A game system comprising one or more processors, the one or more processors being configured to:
start a first game processed based on an operation input by a user and ending when a first condition is satisfied;
start measuring an elapsed time from the start of the first game until the first condition is satisfied, together with the start of the first game;
generate a game image including a first image based on the first game;
if a game state satisfies a second condition in the first game, cause the game state to automatically transition to a state before the second condition is satisfied; and
if the first condition is satisfied in the first game, perform an evaluation process of evaluating the elapsed time measured including a time taken to cause the game state to transition.

39. One or more non-transitory computer-readable storage media having stored therein a game program causing one or more processors of a game system to:
start a first game processed based on an operation input by a user and ending when a first condition is satisfied;
start measuring an elapsed time from the start of the first game until the first condition is satisfied, together with the start of the first game;
generate a game image including a first image based on the first game;
if a game state satisfies a second condition in the first game, cause the game state to automatically transition to a state before the second condition is satisfied; and
if the first condition is satisfied in the first game, perform an evaluation process of evaluating the elapsed time measured including a time taken to cause the game state to transition.

40. A computer implemented method causing one or more processors of a game system to:
start a first game processed based on an operation input by a user and ending when a first condition is satisfied;
start measuring an elapsed time from the start of the first game until the first condition is satisfied, together with the start of the first game;
generate a game image including a first image based on the first game;
if a game state satisfies a second condition in the first game, cause the game state to automatically transition to a state before the second condition is satisfied; and
if the first condition is satisfied in the first game, perform an evaluation process of evaluating the elapsed time measured including a time taken to cause the game state to transition.
